(19) United States
(12) Patent Application Publication
(10) Pub. No.: US 2026/0303012 A1
(43) Pub. Date: Oct. 1, 2026

(54) MODULE-FRAME RACK FOR SOLAR MODULES IN NATUREMOUNT APPLICATIONS

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/630,725

(22) Filed: Mar. 27, 2026

Related U.S. Application Data
(60) Provisional application No. 63/778,704, filed on Mar. 27, 2025.

(51) Int. Cl. H02S 30/10

(52) U.S. Cl. CPC H02S 30/10

(57) ABSTRACT

An apparatus includes an array of at least two solar panel modules. Each solar panel module from the at least two solar panel modules includes a photovoltaic cell and a frame from a plurality of frames. The apparatus also includes a coupler. The coupler has at least a first side and a second side that define an included angle between 0 degrees and 180 degrees. A first solar panel module from the at least two solar panel modules is affixed to the first side of the coupler and a second solar panel module from the at least two solar panel modules is affixed to the second side of the coupler, such that a predefined angle exists between a plane of the first solar panel module and a plane of the second solar panel module.

### CROSS-REFERENCE TO RELATED APPLICATION

This application claims priority to U.S. Provisional Patent Application No. 63/778,704, filed Mar. 27, 2025 and titled “Module-Frame Rack for Naturemount Applications,” the entirety of which is incorporated by reference herein.

### TECHNICAL FIELD

The present disclosure relates generally to solar arrays.

### BACKGROUND

During time periods when power demand exceeds solar power production, some known solar powerplants deliver power to electrical loads using battery energy storage systems (BESS). For example, a known BESS can distribute power to electrical loads when the sun is low or has set, at night, or otherwise during times when power demand exceeds solar power production. Conversely, during time periods when solar power production exceeds power demand, some known solar powerplants deliver power to a BESS to charge the BESS, in anticipation of a future time period when power demand will exceed solar power production. For example, a known BESS can be charged during a time period associated with peak solar power production. For some known solar arrays, peak power production is often at a middle part of the day. Therefore, some known solar powerplants often have a solar power generating capacity that is sufficiently large to produce enough power to serve some (and in some instances, all) connected electrical loads over a 24-hour period (plus some additional power to cover inefficiencies in such systems). Additionally, some known BESS's have capacities that are big enough to serve some (and in some instances, all) the connected electrical loads during time periods when power demand exceeds solar power production.

BESS capacity, however, is expensive. One way to reduce a desired total BESS capacity is to arrange for some electrical loads to operate during peak solar production hours, and for some electrical loads to not operate (and so not consume electricity) during hours being served by the BESS (i.e., when power demand exceeds solar power production). Consequently, a need exists for a solar array with a solar power profile that reduces frequency, duration, and/or power of BESS discharges.

### SUMMARY

In some embodiments, an apparatus includes an array of at least two solar panel modules. Each solar panel module from the at least two solar panel modules includes a photovoltaic cell and a frame from a plurality of frames. Each frame from the plurality of frames includes a first sidewall, a second sidewall opposite the first sidewall, and a third sidewall disposed between, in contact with, and substantially orthogonal to each of the first sidewall and the second sidewall. A first solar panel module from the at least two solar panel modules is fixedly attached to a second solar panel module from the at least two solar panel modules so that the third sidewall of the frame of the first solar panel module abuts at least a portion of the frame (e.g., the first sidewall, the second sidewall, or the third sidewall) of the second solar panel module such that a plane of the first solar panel module is substantially orthogonal to a plane of the second solar panel module.

In some embodiments, an apparatus includes an array of at least two solar panel modules. Each solar panel module from the at least two solar panel modules includes a photovoltaic cell and a frame from a plurality of frames. The apparatus also includes a coupler. The coupler has at least a first side and a second side that define an included angle between 0 degrees and 180 degrees. A first solar panel module from the at least two solar panel modules is affixed to the first side of the coupler and a second solar panel module from the at least two solar panel modules is affixed to the second side of the coupler, such that a predefined angle exists between a plane of the first solar panel module and a plane of the second solar panel module.

In some embodiments, a method of assembling a solar panel assembly includes forming an array of at least two solar panel modules. Each solar panel module from the at least two solar panel modules includes a photovoltaic cell and a frame. The forming includes affixing a first solar panel module from the at least two solar panel modules to a first side of a coupler. The coupler has the first side and a second side. The first side and the second side of the coupler define an included angle between 0 degrees and 180 degrees. The forming also includes affixing a second solar panel module from the at least two solar panel modules to the second side of the coupler, such that a predefined angle exists between a plane of the first solar panel module and the second solar panel module.

### BRIEF DESCRIPTION OF THE DRAWINGS

FIG. 1 depicts solar panel modules on wheeled metal racks.

FIG. 2A depicts a plan view of an example solar panel module frame.

FIG. 2B depicts a partial cross-sectional view of an example solar panel module with the example solar panel module frame of FIG. 2A.

FIG. 3 depicts a system including an example module-frame rack and tray, according to some embodiments.

FIG. 4 depicts a perspective view of a landscape-landscape solar tent with a right angle, according to an embodiment.

FIG. 5 depicts a partial cross-sectional view of a solar tent with a coupler, according to an embodiment.

FIG. 6A depicts a plan view of a landscape-landscape solar tent, according to an embodiment.

FIG. 6B depicts a cross-sectional view of the landscape-landscape solar tent of FIG. 6A with a right angle.

FIG. 7 depicts a plan view of a portrait solar panel module and a landscape solar panel module, according to an embodiment.

FIG. 8 depicts a plan view of a portrait-landscape solar tent, according to an embodiment.

FIG. 9A depicts a cross-sectional view of the portrait-landscape solar tent of FIG. 8, with a right angle.

FIG. 9B depicts a cross-sectional view of a portrait-landscape solar tent of FIG. 8, with a 135 degree angle.

FIG. 10 is a diagram of an example microgrid system for microgrid metering and energy allocation, according to an embodiment.

FIG. 11 is a graph depicting an example power profile of a solar tent, according to an embodiment.

FIG. 12 is a flow diagram of a method for assembling a solar tent, according to an embodiment.

FIG. 13 depicts a perspective view of an example solar tent with a coupler, according to an embodiment.

FIG. 14 depicts a perspective view of an example solar tent with a base-attached splay limiter, according to an embodiment.

FIG. 15 depicts a perspective view of an example solar tent with another base-attached splay limiter, according to another embodiment.

FIG. 16A depicts a perspective view of an example solar tent with ground-attached splay limiters, according to an embodiment.

FIG. 16B depicts the ground-attached splay limiter of FIG. 16A, according to an embodiment.

### DETAILED DESCRIPTION

Some embodiments set forth herein can include one or more transportable solar microutility products (also referred to herein as “Firefly” products or systems), and, examples of Firefly implementations compatible with one or more embodiments of the present disclosure can be found in one or more of U.S. patent application Ser. No. 19/520,125, titled “Wind Deflector for Solar Arrays” and filed Dec. 15, 2025; U.S. Pat. No. 11,531,169, titled “Systems and methods for microgrid metering and energy allocation” and issued Aug. 30, 2022; U.S. Pat. No. 11,589,437, titled “Systems and Methods for Microutility Metering and Energy Allocation” and issued Nov. 1, 2022; U.S. Pat. No. 12,081,021, titled “Systems and methods for microgrid metering and energy allocation” and issued Sep. 3, 2024; U.S. Pat. No. 11,864,577, titled “Systems and Methods for a Mobile Micro Utility” and issued on Sep. 19, 2023; and U.S. Pat. No. 11,824,457, titled “Systems and Methods for a Mobile Micro Utility” and issued on Nov. 21, 2023, the contents of each of which are incorporated by reference herein in their entireties, for all purposes.

In one or more embodiments, a Firefly system includes a NatureMount™ feature(s). As used herein, the term “NatureMount™” can refer, by way of example, to a solar module mounting structure that reduces or minimizes a grading of a terrain, a levelling of a terrain, and/or an amount/presence of a foundation in connection with the placement of the solar module(s) on natural land (e.g., earth). Stated another way, NatureMount can refer to a system that facilitates placement of solar module(s) on natural land with a reduced amount of preparation of the natural land location, as contrasted with known systems/methods.

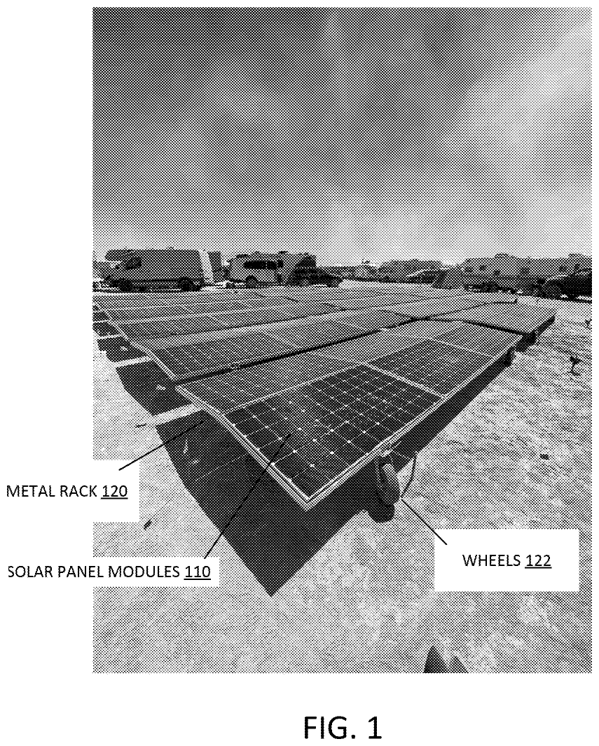

In a first example embodiment of Firefly, a module-frame rack and tray are configured to supplement (or replace), for example, a transportable solar microutility product (e.g., shown in FIG. 1) that includes metal racks for holding solar panel modules in place. The metal racks of FIG. 1 can also include wheels for transporting the solar panel modules during, for example, deployment and take-down. The module-frame rack and tray concept described herein can include a rack having fewer components and that is lighter weight relative to the transportable solar microutility product of FIG. 1 and/or can include a separate “tray” that can be configured to transport the rack during, for example, deployment and take-down. In some embodiments, the module-frame rack can be and/or include a rack that includes solar module frames that are affixed to each other so that the rack is (e.g., almost) entirely composed of the solar module assemblies themselves. Use of module frames as structural supports can facilitate the placement of solar module(s) on natural land without separate racking elements such as the metal racks of FIG. 1, as contrasted with known systems/methods. Such a rack can have limited bending and torsional stiffness such that, if the racks were lifted at their rack end portions (e.g., for transportation), the applied forces can result in bending and cracking of the solar panels in the solar panel modules. Therefore, a “tray” can be configured to provide functionality of an additional support during, for example, deployment and/or take-down. The rack can be removably coupled to the tray. For example, the rack can be placed on (or affixed to) the tray during a first time period and removed from (or unaffixed to) the tray during a second time period different from the first time period so that the tray can support other racks.

In a second example embodiment of Firefly, a module-frame rack and tray includes a module-frame rack with a 90-degree angle. The module-frame rack with a 90-degree angle can be an implementation of the module-frame rack that includes a first set of solar module frames that is coupled (e.g., affixed, etc.) to a second set of solar modules frames such that a plane of the first set of solar module frames has a substantially 90-degree angle (or be substantially orthogonal) relative to a plane of the second set of solar module frames. The 90-degree module-frame rack implementation can enable solar module frames to be joined flat-surface-to-flat-surface without additional parts (e.g., without a coupler). In some embodiments, a more generic implementation of the modular frame rack can include a coupler configured to be placed and/or positioned between a frame of the first set of solar panel module(s) and a frame of the second set of solar panel module(s). For example, the coupler can be and/or include a metal angle (e.g., a mass produced metal angular structure, such as a structural steel angle, or other standard such as an aluminum angle, a metallic bar with faces machined to an angle, an extruded aluminum part with a predefined angle, etc.).

In a third example embodiment of Firefly, a solar module rack and/or tray includes a portrait and/or landscape “tent.” In the transportable solar microutility product of FIG. 1, racks can be configured to hold solar panel modules in a relatively flat, inverted “V” configuration to facilitate, for example, water runoff. A variation of the flat, inverted “V” configuration, in accordance with some embodiments, steepens the “V” and makes the “V” asymmetric, with the east-tilted solar panel modules being tilted at a relatively steep angle and the west-tilted solar panel modules being tilted at a relatively flatter/shallower angle. In embodiments where the rack results from (or is defined by) coupling (e.g., affixing, etc.) the frames of the solar panel modules to each other, the tilt and asymmetry of the portrait-landscape tent can be achieved by orientating the east-facing solar panel modules in a landscape orientation and orienting the west-facing solar panel modules in a portrait orientation (or vice versa), as described in further detail herein.

In addition to the foregoing example implementation details, the present disclosure also includes a concept for incorporating additional energy-consuming services that are under common control with the energy generation and energy storage subsystems of one or more Firefly embodiments. Such services can deliver value to the community served by the one or more Firefly embodiments. By being under common control, loads can serve as controllable electrical loads, helping to reduce the need for relatively expensive battery energy storage capacity relative to similar services operated under third-party control.

FIG. 1 depicts solar panel modules on wheeled metal racks. FIG. 1 includes solar panel modules 110 and metal rack 120, which collectively define a transportable solar microutility product that does not include the module-frame rack described herein. Metal rack 120 includes wheels 122. In FIG. 1, the solar panel modules 110 can be fixedly coupled to (e.g., clamped into, etc.) metal rack 120 so that metal rack 120 holds the solar panel modules 110 in place (e.g., in a specified configuration/orientation). Metal rack 120 can be a wheeled support for supporting the solar panel modules 110 and for transporting the solar panel modules 110 during, for example, deployment and take-down. Metal rack 120 can, however, include additional materials relative to some embodiments herein and can involve significant manufacturing effort. For example, many metal parts are cut and welded to each other, and the flat “V” shape involves machining of the frame parts to a specific angle.

Solar panels are typically shipped as an assembly (also referred to herein as a module) that includes a lightweight frame. The frame can help to prevent bending of the solar panel module during handling, which is desirable because the solar panel associated with the solar panel module can otherwise be easily damaged by bending. The frame can also provide a structure that can be clamped when mounting the solar panel module, which is desirable because clamping onto the solar panel itself can crack or otherwise damage the solar panel.

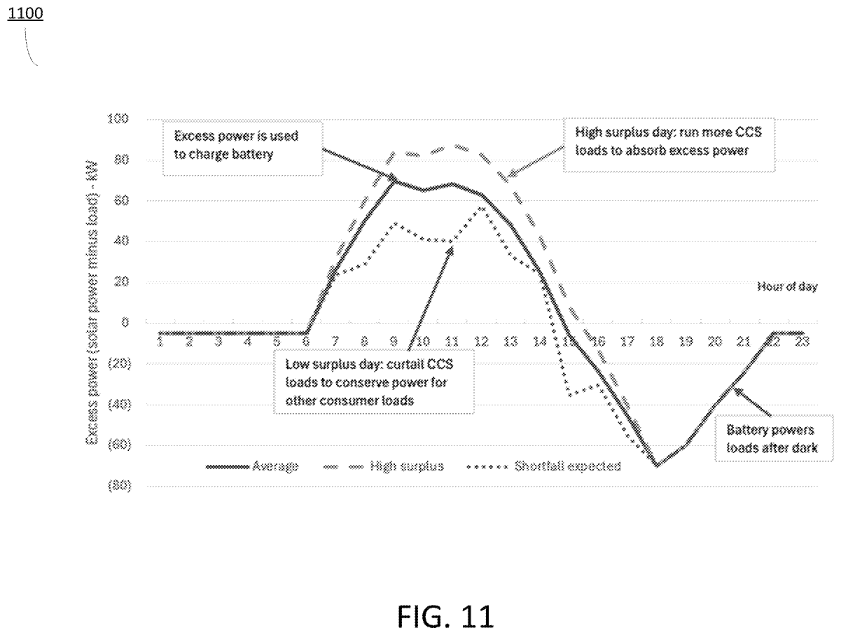

In FIG. 1, the metal rack 120 is configured to hold the solar panels in a flat, inverted “V” configuration for water runoff. The inverted “V” shape is not solely useful for running off water, however. For example. when the axis of the “V” is oriented north-south, the east-tilted solar panel modules from solar panel modules 110 can generate more power in the earlier morning than that generated by solar panel modules that are aimed directly upward, and the west-tilted solar panel modules from solar panel modules 110 can generate more power in the afternoon than that generated by solar panel modules that are aimed directly upward. During the center part of the day (e.g., around noon/midday), both the east-tilted solar panel modules and the west-tilted solar panel modules can produce somewhat less power than that generated by solar panel modules that are aimed directly upward. The result is that a solar rack with an inverted “V” configuration can produce a flatter power profile throughout the day than that of a flat solar rack, although total energy production of the solar rack with the inverted “V” configuration can also be slightly lower. The flatter power profile, with the lower peak value, can improve the match between power production and typical electrical load profiles, reducing reliance on (costly) energy storage capacity. An example power profile of a solar rack with an inverted “V” configuration is shown and described with respect to FIG. 11.

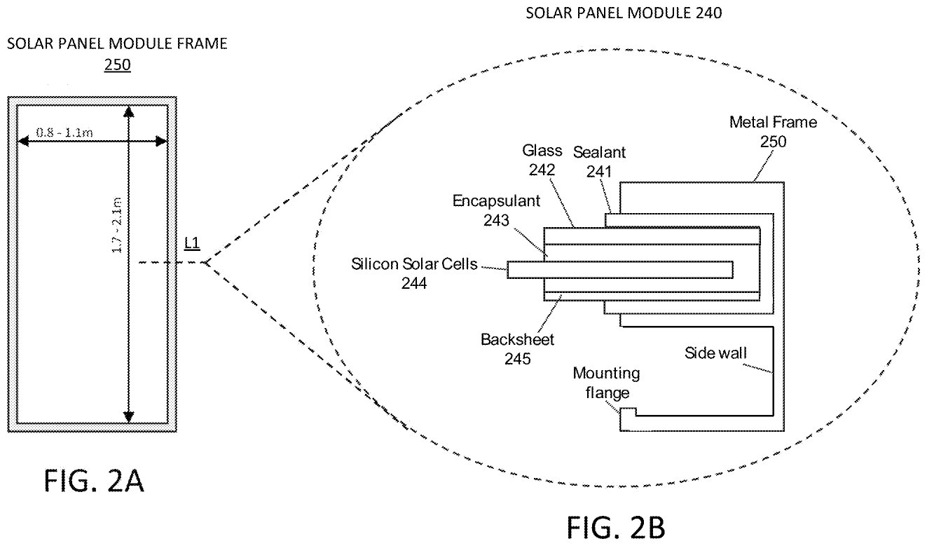

FIG. 2A depicts a plan view of an example solar panel module frame 250 (or simply, frame 250). As shown in FIG. 2A, frame 250 can have a substantially rectangular shape with four sides. Two sides from the frame 250 can have a length from a range of lengths, for example, between about 1.7 meters and about 2.1 meters. The two remaining sides from the frame 250 can have a length from a range of lengths, for example, between about 0.8 meters and about 1.1 meters. FIG. 2A depicts a cross-section line L1.

FIG. 2B depicts a partial cross-sectional perspective view of an example solar panel module 240 with the example solar panel module frame 250 of FIG. 2A. The cross-sectional perspective view can be taken at, for example, the cross-section line L1 of FIG. 2A. The frame 250 can have a substantially E-shaped cross-section with a frame top leg, a frame middle leg, a frame bottom leg, and a frame sidewall that mechanically couples the frame top leg, frame middle leg, and the frame bottom leg together. The bottom leg of the “E” can have a length that is longer (e.g., 2% longer, 5% longer, 10% longer, etc.) than the top leg of the “E. In some implementations, the bottom leg of the “E” can have a length that is shorter than the top leg of the “E”. The frame sidewall can provide strength to the frame 250. The frame bottom leg can include a mounting flange portion that is disposed between remaining portions of the frame bottom leg and the frame middle leg. Remaining portions of the solar panel module 240 can include, by way of example, sealant 241, glass 242, encapsulant 243, silicon solar cells 244, and backsheet 245.

Sealant 241 can be sized and shaped to substantially fill a space between frame 250 and remaining portions of solar panel module 240, allowing the remaining portions of solar panel module 240 (e.g., glass 242, encapsulant 243, silicon solar cells 244, and backsheet 245) to be inserted into frame 250 and restricting moisture from reaching silicon solar cells 244. For example, sealant 241 can have a substantially square U-shaped cross-section with a seal base, a seal top leg, and a seal bottom leg, as shown in FIG. 2B.

Encapsulant 243 can have a substantially square U-shaped cross-section with an encapsulant base, an encapsulant top leg, and an encapsulant bottom leg. The encapsulant base can mechanically couple the encapsulant top leg and the encapsulant bottom leg and is substantially orthogonal to each of the encapsulant top leg and the encapsulant bottom leg. The encapsulant top leg can be disposed between glass 242 and silicon solar cells 244. The encapsulant bottom leg can be disposed between silicon solar cells 244 and backsheet 245. The encapsulant base can have a length (relative to the frame sidewall of frame 250) that is longer than a length of the seal top leg of sealant 241 and/or a length of the seal bottom leg of sealant 241, as shown in FIG. 2B. Each of the encapsulant top leg and the encapsulant bottom leg can have a thickness that is less than (e.g., 50% less than, 60% less than, 70% less than, etc.) a thickness of the glass 242, a thickness of the seal top leg of sealant 241, a thickness of the seal bottom leg of sealant 241, a thickness of the frame top leg of frame 250, a thickness of the frame middle leg of frame 250, a thickness of the frame bottom leg of frame 250, and/or a thickness of the frame sidewall of frame 250, as shown in FIG. 2B.

Some embodiments herein include a module-frame rack with a substantially E-shaped cross section, as depicted in FIG. 2B. Some embodiments herein include a module-frame rack with a substantially F-shaped cross section that does not include a mounting flange. Some embodiments herein include a module-frame rack with a substantially square U-shaped cross-section (e.g., a symmetric square U-shaped cross-section with two substantially equally sized legs, an asymmetric square U-shaped cross-section with two different sized legs, etc.). Some embodiments herein include a module-frame rack with a substantially C-shaped cross-section (e.g., a symmetric C-shaped cross-section, an asymmetric C-shaped cross-section, etc.).

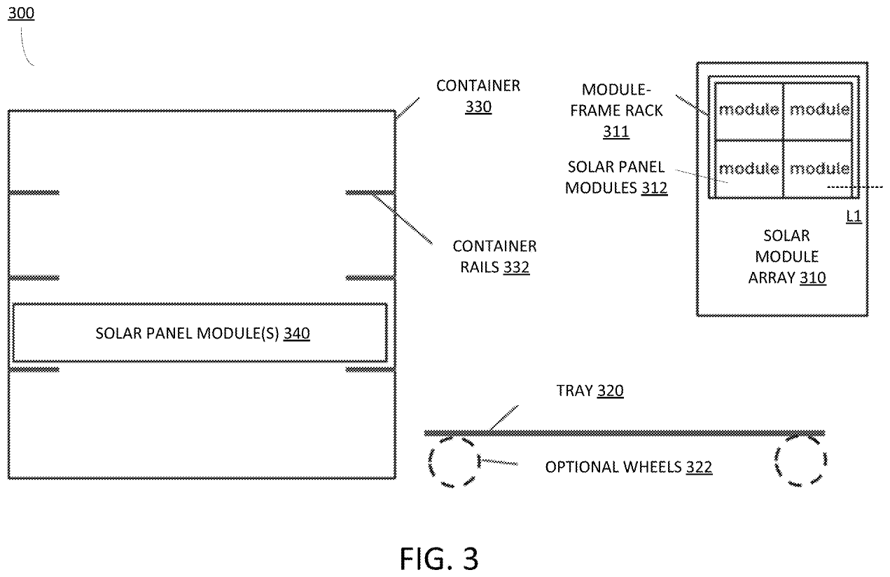

FIG. 3 depicts a system 300 including an example module-frame rack and tray, according to some embodiments. System 300 can be and/or include a transportable solar microutility system, for example as described in U.S. provisional patent application No. 63/878,804, filed Mar. 27, 2025 and titled “Module-Frame Rack for Naturemount Applications,” or as described in U.S. patent application Ser. No. 19/550,438, filed Jan. 15, 2026 and titled “Wind Deflector for Solar Arrays,” the entire contents of each of which are incorporated by reference herein. System 300 includes solar module array 310, tray 320, container 330, and solar panel modules 340. Container 330 can mechanically support one or multiple solar panel modules 340. In some implementations, solar module array 310 (or portions thereof) can be removably coupled to (or removably mechanically supported by) a tray 320. In some implementations, solar panel modules 340 can be and/or include solar panel modules 312 associated with solar module array 310. For example, solar panel modules 340 can be transported between container 330 and solar module array 310 by container 330.

Solar module array 310 includes solar panel modules 312 and module-frame rack 311. Module-frame rack 311 can be mechanically coupled to solar panel modules 312. The module-frame rack 311 can be and/or include two or more solar panel module frames configured to provide functionality of a rack (e.g., metal rack 120 of FIG. 1 or other racks, not shown in FIG. 3) as a support for solar panel modules 312. That is, the solar panel module frames can be affixed to each other directly, or almost so, with minimal or no other parts being used. Such a configuration can be achieved by, for example, disposing/arranging solar panel modules 312 in a flat (or tilted) array and affixing the frames of the solar panel modules 312 together “edge-to-edge” such that a sidewall of a first frame of a first set of solar panel modules from solar panel modules 312 abuts a sidewall of a second frame of a second set of solar panel modules from solar panel modules 312. Affixing can involve, for example, clamps, nuts and bolts, rivets, welding and/or bonding. For example, solar panel module frames that include aluminum can be readily bonded.

In some implementations, module-frame rack 311 can have a substantially E-shaped cross section, as depicted in FIG. 2B. In some implementations, module-frame rack 311 can have a substantially F-shaped cross section that does not include a mounting flange. In some implementations, module-frame rack 311 can have a substantially square U-shaped cross-section (e.g., a symmetric square U-shaped cross-section with two substantially equally sized legs, an asymmetric square U-shaped cross-section with two different sized legs, etc.). In some implementations, module-frame rack 311 can have a substantially C-shaped cross-section (e.g., a symmetric C-shaped cross-section, an asymmetric C-shaped cross-section, etc.).

Tray 320 can be configured to transport solar module array 310 (or portions thereof) to and/or from container 330. Tray 320 can optionally include wheels 322. In some implementations, tray 320 can be caused to move between container 330 and a location that includes (or previously included, or will include) solar module array 310.

Each solar panel frame from module-frame rack 311 can be configured (e.g., by the module manufacturer) to be sufficiently stiff to prevent flexing of the solar panels from solar panel modules 312 during, for example, handling. When solar panel module frames are affixed to each other to define a larger rack (e.g., module-frame rack 311), however, and such a rack is handled (e.g., for deployment or take-down), the additional length and weight can create a risk of causing flexing and cracking of the solar panels. The tray 320 can be configured to provide functionality of an additional support for mechanically supporting the module-frame rack 311 while the module-frame rack 311 is being relocated, for example to deploy the module-frame rack 311 from container 330 (e.g., a delivery enclosure) to an installation (or deployment) site, or to return the rack to container 330 (e.g., the delivery enclosure). The tray 320 can be configured to be sufficiently stiff to prevent bending or twisting of the module-frame rack 311 while both the tray 320 and the module-frame rack 311 are being transported, for example by carrying (involving multiple people) or by using optional wheels attached to the tray 320. Once module-frame rack 311 has been moved and removed from the tray 320, the tray 320 can be configured to transport another module-frame rack (not shown in FIG. 3) different from the module-frame rack 311.

Container 330 can be configured to store and/or transport solar panel modules including solar panel modules 340 and/or solar panel modules 312. Container 330 can include container rails 332. Container rails 332 can include any appropriate number (e.g., three) of pairs of rails (e.g., that will fit inside the container 330), where each pair of rails includes a first rail portion coupled to a first side of container 330 and a second rail portion coupled to a second side of container 330 that is opposite to and facing the first side of container 330. Each pair from container rails 332 can be configured to mechanically support a single solar panel module from solar panel modules 340. In some implementations, container rails 332 can be configured to provide a surface for coupler(s) (not shown) to couple solar panel modules 340 to container rails 332.

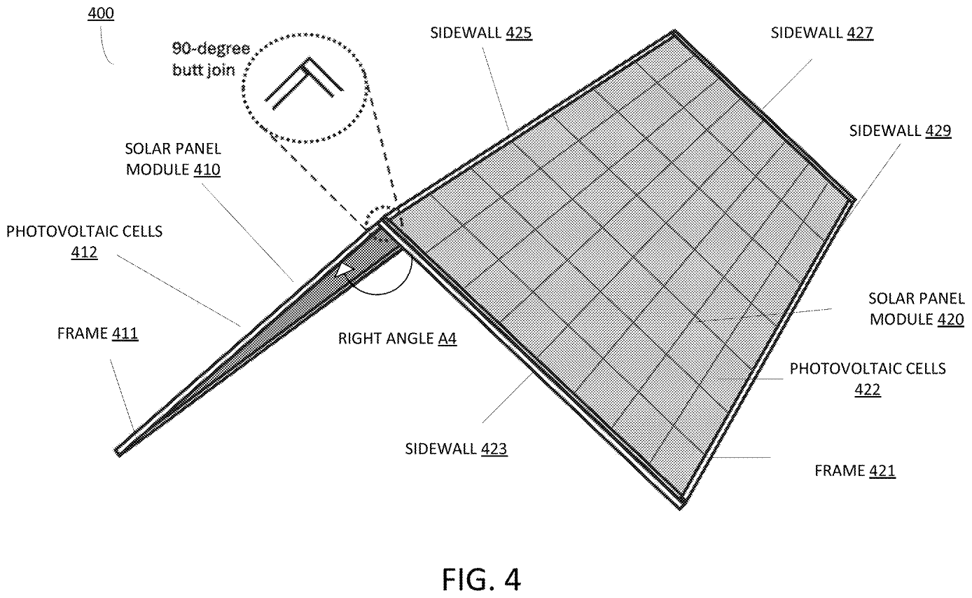

FIG. 4 depicts a perspective view of a landscape-landscape solar tent 400 (or simply, solar tent 400) with a right (i.e., 90-degree) angle A3, according to an embodiment. FIG. 4 depicts an implementation of the module-frame rack, in which solar tent 400 has an inverted “V” shape. In some implementations, the inverted “V” shape of solar tent 400 can be created by affixing the solar panel frames (i.e., frame 411 and frame 421) to each other at a 90-degree angle. The solar panel frames can, for example, be joined flat-surface-to-flat-surface (e.g., in a 90-degree or substantially 90-degree “butt join,” as shown in FIG. 4) without any additional parts. Accordingly, solar tent 400 includes solar panel module 410 and solar panel module 420 and, in some implementations, may not include components other than solar panel module 410 and solar panel module 420, such as a coupler. Solar panel module 410 includes frame 411 and photovoltaic cells 412. Photovoltaic cells 412 can define a solar panel associated with solar panel module 410. Frame 411 can be coupled (e.g., mechanically coupled, adhesively coupled, etc.) to photovoltaic cells 412. Solar panel module 420 includes frame 421 and photovoltaic cells 422. Photovoltaic cells 422 can define a solar panel associated with solar panel module 420. Frame 421 can be coupled (e.g., mechanically coupled, adhesively coupled, etc.) to photovoltaic cells 422.

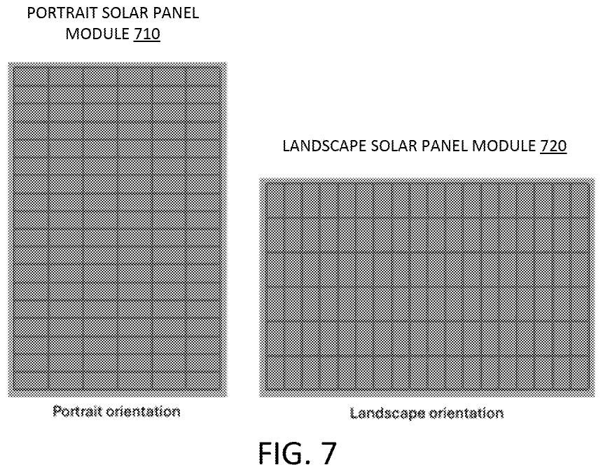

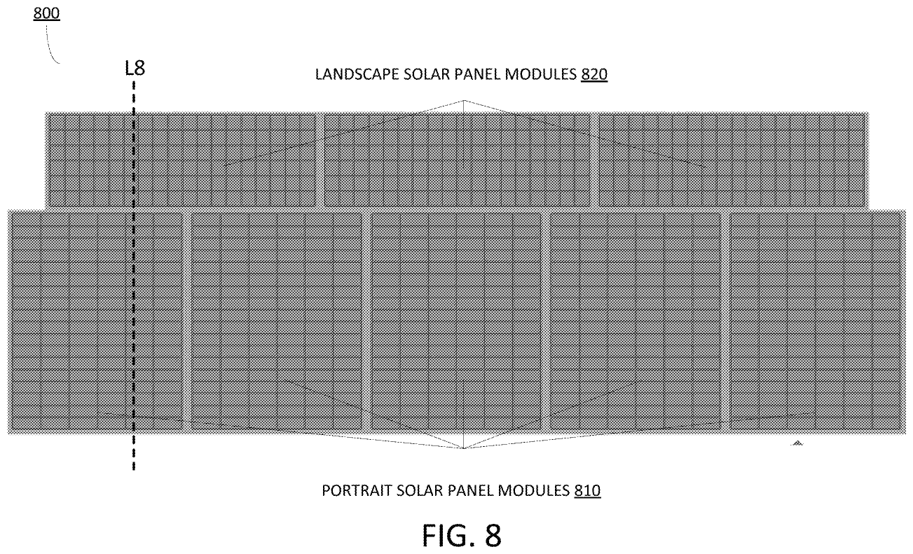

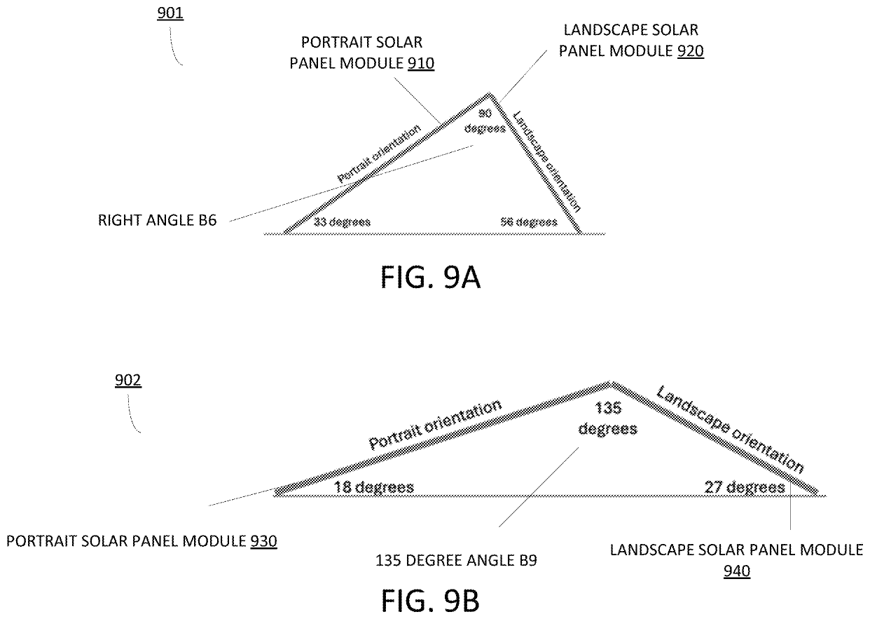

Frame 421 and frame 411 can each include, for example, aluminum (e.g., anodized aluminum, an aluminum alloy(s), etc.), steel, a composite material(s), and/or any other suitable material(s). Frame 421 includes sidewall 423, sidewall 425, sidewall 427, and sidewall 429. Although the perspective view of FIG. 4 does not depict in detail the photovoltaic cells of solar panel module 410 or the sidewalls of frame 411, it is to be understood that solar panel module 410 includes such components. Each of sidewall 423, sidewall 425, sidewall 427, and sidewall 429 can be a different (i.e., no more than partially overlapping) portion of frame 421. As depicted, sidewall 423 can be a portion of frame 421 that is opposite and substantially parallel to sidewall 427 and that is substantially orthogonal to each of sidewall 425 and sidewall 429. Similarly, sidewall 425 can be a portion of frame 421 that is opposite and substantially parallel to sidewall 429 and that is substantially orthogonal to each of sidewall 423 and sidewall 427. As depicted, each of sidewall 425 and sidewall 429 can be longer than each of sidewall 423 and sidewall 427, such that solar panel module 420 is understood to be in a “landscape” orientation relative to remaining portions of solar tent 400. Solar panel module 410, although partially obscured by the perspective view of FIG. 4, is also in a “landscape” orientation relative to remaining portions of solar tent 400, such that solar panel module 410 and solar panel module 420 define a landscape-landscape (or symmetric) solar tent (i.e., landscape-landscape solar tent 400). In some implementations, however, a sidewall with a same relative position as sidewall 425 can be shorter than a sidewall with a same relative position as sidewall 423 and/or a sidewall with a same relative position as sidewall 427, such that a solar panel module is understood to be in a “portrait” orientation relative to remaining components of such a solar tent. For example, FIG. 7 shows a solar panel module in such a “portrait” orientation. In some embodiments, at least one solar panel module of a solar tent can have an orientation different from an orientation of at least one remaining solar panel module of a solar tent. For example, FIGS. 8 and 9A-9B each show a different solar tent that each include at least one solar panel module in a landscape orientation and at least one solar panel module in a portrait orientation, to define a portrait-landscape (or asymmetric) solar tent.

Solar panel module 420 can be fixedly attached to solar panel module 410 so that sidewall 425 abuts at least a portion of a sidewall (e.g., a sidewall that is partially obscured by the perspective view of FIG. 4) of solar panel module 420 such that a plane of solar panel module 420 is substantially orthogonal to a plane of solar panel module 410. Stated similarly, solar panel module 410 can be fixedly attached to solar panel module 420 such that a plane of solar panel module 420 and a plane of solar panel module 410 form (or define) right angle A3. Solar panel module 410 can be fixedly attached to solar panel module 420 via, for example, an adhesive(s), a laminate(s), a fastener(s), epoxy, a brazed joint(s), a clamp(s), nuts, bolts, rivets, welds, and/or the like.

In some implementations, solar panel module 410 can be attached to solar panel module 420 via a fastener such that when solar panel module 410 is rotated relative to solar panel module 420, solar panel module 410 and solar panel module 420 locks into place in a configuration having right angle A4 to define a type of clamshell configuration of solar tent 400, such as the clamshell configurations described in U.S. patent application Ser. No. 19/340,125, filed Dec. 15, 2025 and titled “Naturemount Solar Arrays,” the entirety of which is incorporated by reference herein. In some implementations, solar panel module 410 can be hingedly attached (e.g., via a hinge) to solar panel module 420 to define another type of clamshell configuration of solar tent 400. In some implementations, solar panel module 420 can be fixedly attached to solar panel module 410 via an adhesive extending along at least a portion (e.g., an eighth, a quarter, a half, etc.) of a length of sidewall 425. In some implementations, solar panel module 420 can be fixedly attached to solar panel module 410 only via an adhesive. In some implementations, solar panel module 420 can be fixedly attached to solar panel module 410 only via a fastener. In some implementations, solar panel module 420 can be fixedly attached to solar panel module 410 only via a laminate.

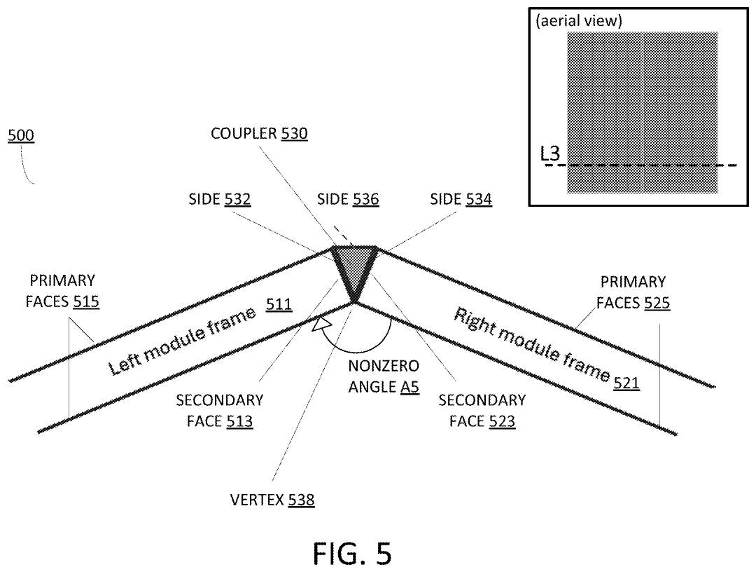

In some embodiments, a solar panel module can be fixedly attached to a second solar panel module such that a nonzero angle therebetween is different from 90-degrees, for example about 45 degrees, about 135 degrees, etc. In some embodiments, a more general implementation can involve affixing solar panel frames, not directly to each other, but to a coupler placed between them. For example, FIG. 5 shows such a configuration for a solar tent.

FIG. 5 depicts a partial cross-sectional view of a solar tent 500 with a coupler, according to an embodiment. The partial cross-sectional view is taken at the cross-section line L3 shown (from an aerial perspective) at the inset of FIG. 5. Solar tent 500 includes left module frame 511 (e.g., structurally and/or functionally similar to frame 411 of FIG. 4), right module frame 521 (e.g., structurally and/or functionally similar to frame 421 of FIG. 4), and coupler 530. Coupler 530 can be disposed between left module frame 511 and right module frame 521 to form solar tent 500 with nonzero angle A4.

Although not depicted in detail in the partial cross-sectional view of FIG. 5, it is to be understood that left module frame 511 is included with a first solar panel module (e.g., solar panel module 410 of FIG. 4) that has primary faces 515 and secondary face 513 and that right module frame 521 is included with a second solar panel module (e.g., solar panel module 420 of FIG. 4) that has primary faces 525 and secondary face 523. Primary faces 515 can include an active solar surface of the solar panel module associated with left module frame 511, and an inactive solar surface of the solar panel module associated with left module frame 511. For example, the active solar surface of primary faces 515 can include photovoltaic cells (e.g., photovoltaic cells 412 of FIG. 4). Similarly, primary faces 525 can include an active solar surface of the solar panel module associated with right module frame 521, and an inactive solar surface of the solar panel module associated with right module frame 521. For example, the active solar surface of primary faces 525 can include photovoltaic cells (e.g., photovoltaic cells 422 of FIG. 4). The inactive solar surface of primary faces 515 can be opposite and substantially parallel to the active solar surface of primary faces 515. Similarly, the inactive solar surface of primary faces 525 can be opposite and substantially parallel to the active solar surface of primary faces 525. Secondary face 513 can be a portion of left module frame 511 that is smaller than and substantially orthogonal to primary faces 515. In some implementations, secondary face 513 can be structurally and/or functionally similar to a sidewall of solar panel module 410 of FIG. 4. Similarly, secondary face 523 can be a portion of right module frame 521 that is smaller than and substantially orthogonal to primary faces 525. In some implementations, secondary face 523 can be structurally and/or functionally similar to sidewall 425 of solar panel module 420 of FIG. 4.

Coupler 530 can be and/or include any material that is sufficiently strong to mechanically support left module frame 511 and right module frame 521 such that left module frame 511 and right module frame 521 form solar tent 500 with nonzero angle A4. For example, coupler 530 can be and/or include a metal structure that defines an angle between two surfaces such as a standard mass-produced metal angle or a purpose-made angle (e.g., an aluminum extrusion). Coupler 530 has a triangular cross-section with three vertices (i.e., angular points) defined by side 534, side 534, and side 536. Each of side 532, side 534, and side 536 can be a different surface of coupler 530. As shown, side 536 is disposed between side 532 and side 534. Vertex 538 is the angular point (or the set of angular points) that connects side 532 and side 534. A first included angle defined by side 532, vertex 538, and side 534 is about 45 degrees. A second vertex exists between side 532 and side 536 (defining a second included angle of about 67.5 degrees) and a third vertex exists between side 534 and side 536 (defining a third included angle of about 67.5 degrees). Accordingly, the triangular cross-section of coupler 530 is a triangular acute isosceles that represents a cross-section of the coupler 530.

In some embodiments, a coupler can have a cross-section shape with included angles different from those of coupler 530 and from a range of included angles no less than about 0 degrees and no more than about 180 degrees. For example, a coupler can have a triangular acute cross-section with three included angles, each about 60 degrees. Instead, a coupler can have a triangular scalene cross-section with three included angles, each of a different measure relative to the remaining included angles. Instead, a coupler can have a triangular isosceles cross-section with three included angles, two included angles being about 45 degrees and the remaining included angle being about 90 degrees. In some implementations, a coupler can have a cross-section shape different than a triangular cross-section, such as polygonal, oval, ellipse shaped, hexagonal, rectangular, circular, symmetric, asymmetric, regular, irregular, and/or the like. In some implementations, a coupler can have an included angle of about 10 degrees, about 20 degrees, about 30 degrees, about 35 degrees, about 40 degrees, about 45 degrees, about 50 degrees, about 55 degrees, about 60 degrees, about 70 degrees, about 75 degrees, about 90 degrees, about 120 degrees, about 135 degrees, about 140 degrees, about 145 degrees, about 150 degrees, about 160 degrees, about 170 degrees, and/or another included angle from the range of included angles.

Coupler 530 can be affixed to left module frame 511 and to right module frame 521 such that nonzero angle A4 exists between a plane of a solar panel module associated with left module frame 511 and a solar panel module associated with right module frame 521. Side 532 can be disposed between left module frame 511 (e.g., secondary face 513) and remaining portions of coupler 530. As shown, side 532 and vertex 538 each contact secondary face 513, where side 532 can be affixed to secondary face 513. Side 534 can be disposed between right module frame 521 (e.g., secondary face 523) and remaining portions of coupler 530. As shown, side 534 and vertex 538 each contact secondary face 523, where side 534 can be affixed to secondary face 523. The acute isosceles triangular cross-section of coupler causes nonzero angle A4 of solar tent 500 to be about 135 degrees. In some implementations, however, a solar tent can be configured to have a predefined angle other than about 135 degrees. For example, a coupler can cause a solar tent to have a predefined angle from a range of predefined angles that is no less than about 0 degrees and no more than about 180 degrees. In some embodiments, a coupler can cause a solar tent to have a predefined angle of about 10 degrees, about 20 degrees, about 30 degrees, about 45 degrees, about 60 degrees, about 75 degrees, about 90 degrees, about 120 degrees, about 135 degrees, about 140 degrees, about 145 degrees, about 150 degrees, about 160 degrees, about 170 degrees, and/or another predefined angle from the range of predefined angles.

In some embodiments, a first side of a coupler can be configured to be affixed to a primary face of a first solar panel module, and a second side of a coupler can be configured to be affixed to a secondary face of a second solar panel module. For example, a coupler side with a same relative position as side 532 can be affixed to a first solar panel module primary face with a same relative position as secondary face 513, and a coupler side with a same relative position as side 536 can be affixed to a second solar panel module primary face with a same relative position as the inactive solar surface of primary faces 525 (or vice versa). In some embodiments, a vertex of a coupler can be configured to contact a primary face of a first solar panel module and to contact a secondary face of a second solar panel module. In the previous example, a vertex with a same relative position as the vertex between side 532 and side 536 can contact each of the first solar panel module secondary face and the second solar panel module primary face. Such configurations can extend to couplers with cross-section shapes different from that of coupler 530.

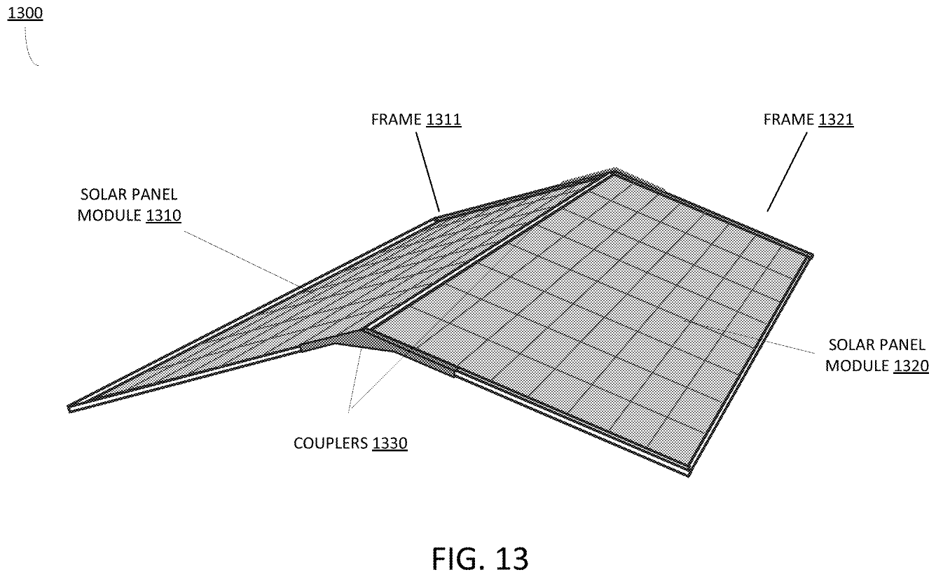

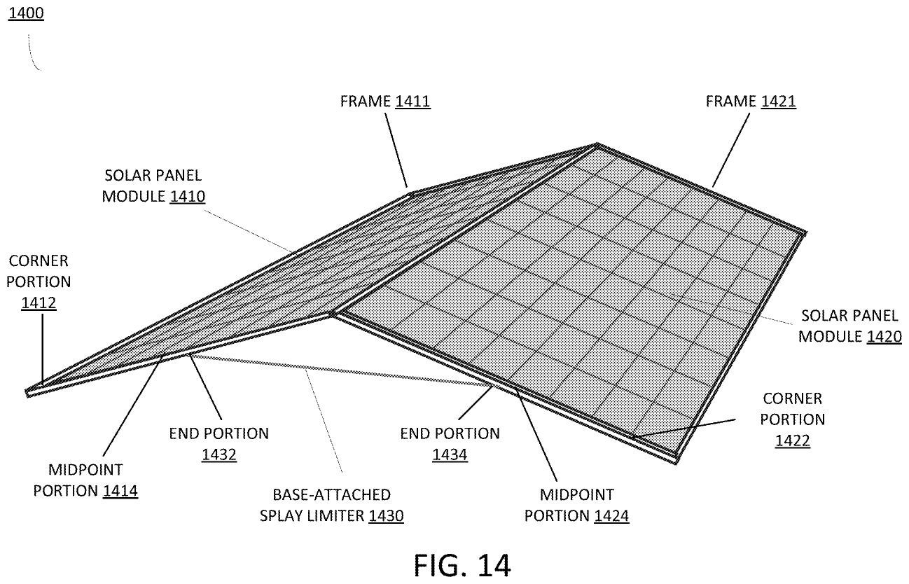

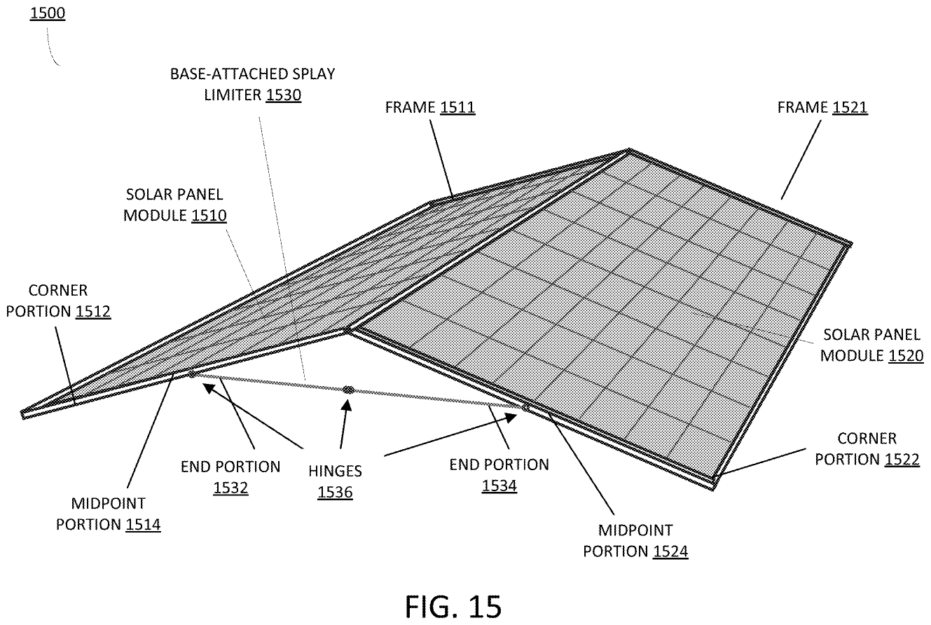

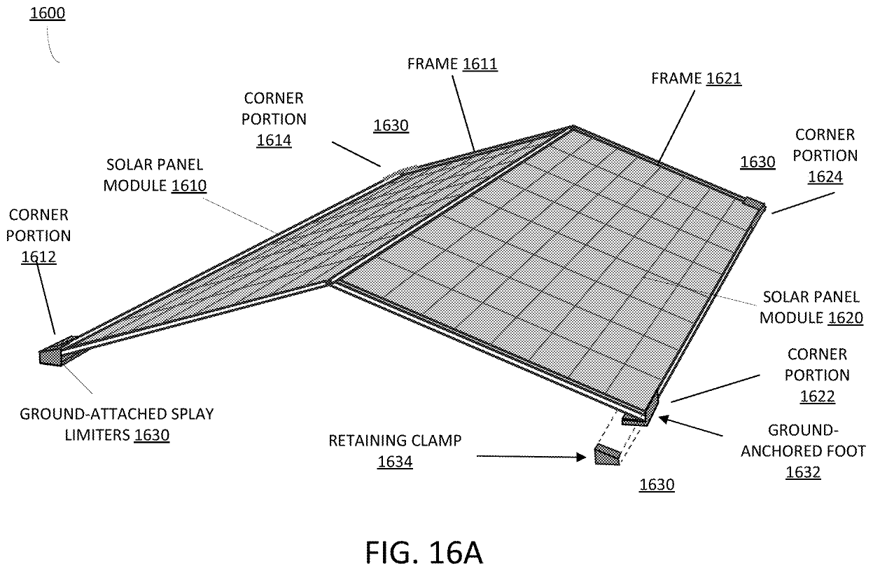

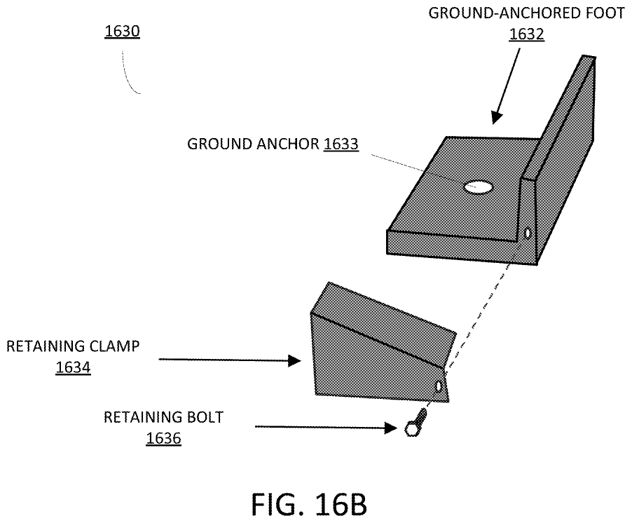

In some implementations, as an alternative to or in addition to coupler 530, solar tent 500 can include one or more other types of couplers, for example, the couplers 1330 of FIG. 13 and/or one or more splay limiters, for example, the base-attached splay limiter 1430 of FIG. 14, the base-attached splay limiter 1530 of FIG. 15 and/or the ground-attached splay limiter 1630 of FIGS. 16A-B.

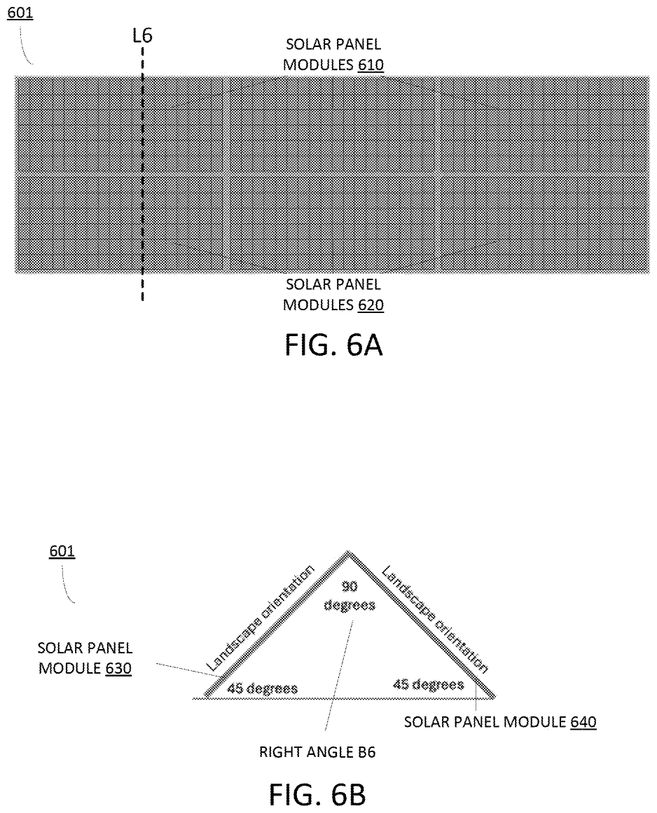

FIG. 6A depicts a plan view of a landscape-landscape solar tent 601, according to an embodiment. Landscape-landscape solar tent 601 includes solar panel modules 610 and solar panel modules 620. Solar panel modules 610 includes three solar panel modules and solar panel modules 620 includes three solar panel modules different from the three solar panel modules of solar panel modules 610. Each solar panel module from solar panel modules 610 and each solar panel module from solar panel modules 620 is oriented in a landscape orientation with respect to an apex of the landscape-landscape solar tent 601, has substantially the same size (e.g., dimensions of length and width) as the remaining solar panel modules and has substantially the same shape (e.g., a rectangle) as the remaining solar panel modules. A set of shorter sidewalls of solar panel modules 610 (e.g., the sidewalls of solar panel modules 610 that are shorter than remaining sidewalls of solar panel modules 610) can be coupled together, for example via adhesives, laminates, and/or fasteners, to form a first row that abuts an apex of landscape-landscape solar tent 601. Similarly, a set of shorter sidewalls of solar panel modules 620 can be coupled together to form a second row that abuts the apex of landscape-landscape solar tent 601. A set of elongate sidewalls of solar panel modules 610 (e.g., the sidewalls of solar panel modules 610 that are longer than remaining sidewalls of solar panel modules 610) can be affixed to a set of elongated sidewalls of solar panel modules 620 to form an array that includes the first row and the second row, the first row being on one side of the apex and the second row being on an opposite side of the apex.

FIG. 6A shows how six solar modules, each being mounted in a “landscape” orientation, with the frames joined (or affixed) at a nonzero (e.g., 90-degree, etc.) angle along the apex of the array can define a solar “tent” (or inverted “V” structure), with solar panel modules 610 and solar panel modules 620 tilted at a substantially same angle (e.g., 45 degrees when the nonzero angle is 90 degrees, etc.) to the horizon on both sides of the apex. In some implementations, solar panel modules 610 and/or solar panel modules 620 can include for example one or more 108-cell 400 W solar panel modules, with dimensions 1.72×1.13 m. Landscape-landscape solar tent 601 does not include a coupler (such as, e.g., coupler 530 of FIG. 5). In some embodiments (e.g., embodiments that have a predefined angle other than 90 degrees), a landscape-landscape solar tent can include a coupler.

In some embodiments, at least one solar panel module from a first row of solar panel modules of a landscape-landscape solar tent and/or at least one solar panel from a second row of solar panel modules of a landscape-landscape solar tent can have a size and/or a shape that is different from a size and/or shape of remaining solar panel modules. For example, in some embodiments, a first solar panel module from a first row of solar panel modules can be smaller than (or larger than) remaining solar panel modules from the first row of solar panel modules and/or smaller than (or larger than) remaining solar panel modules from a second row of solar panel modules.

In some implementations, landscape-landscape solar tent 601 can include one or more types of couplers such as, for example, the coupler 530 of FIG. 5, the couplers 1330 of FIG. 13, or another type of coupler(s) such as hinges disposed along a ridgeline (or apex) of solar tent 1300. In some implementations, landscape-landscape solar tent 601 can include one or more splay limiters such as, for example, the base-attached splay limiter 1430 of FIG. 14, the base-attached splay limiter 1530 of FIG. 15 and/or the ground-attached splay limiter 1630 of FIGS. 16A-16B.

FIG. 6B depicts a cross-sectional view of the landscape-landscape solar tent 601, having with a right angle. The cross-sectional view of FIG. 6B is taken at cross-section line L6 of FIG. 6A. Landscape-landscape solar tent 601 is an implementation where a right angle exists between a plane of solar panel modules 610 of FIG. 6A and a plane of solar panel modules 620 of FIG. 6A. As shown, solar panel module 630 can be affixed to solar panel module 640 such that a right angle exists between a plane of solar panel module 630 and a plane of solar panel module 640, a 45-degree angle exists between solar panel module 630 and a surface that supports landscape-landscape solar tent 601, and a 45-degree angle exists between solar panel module 640 and the surface that supports landscape-landscape solar tent 601. Landscape-landscape solar tent 601 does not include a coupler (e.g., coupler 530 of FIG. 5). In some embodiments (e.g., embodiments that have a predefined angle other than 90 degrees), a landscape-landscape solar tent can include a coupler.

FIG. 7 depicts a plan view of a portrait solar panel module 710 and a landscape solar panel module 720, according to an embodiment. In some implementations, a shorter sidewall of portrait solar panel module 710 can be affixed to an elongated sidewall of landscape solar panel module 720 to form a portrait-landscape solar tent in an asymmetric “V” configuration, an example of which is shown and described with respect to FIG. 8. In the asymmetric “V” configuration, the landscape solar panel module 720 can be at a relatively steeper angle with respect to a surface that supports the portrait-landscape solar tent and the portrait solar panel module 710 can be at a relatively flatter angle with respect to the surface. In some implementations, the landscape solar panel module 720 can be deployed onto a surface such that an active solar surface of the landscape solar panel module 720 is east-tilted, and the portrait solar panel module 710 can be deployed onto the surface such that an active solar surface of portrait solar panel module 710 is west-tilted.

Such a portrait-landscape solar tent can provide a more efficient battery charging and/or discharging schedule for a battery (not shown) coupled to portrait-landscape solar tent and/or reduce frequency/intensity of battery discharge. For example, battery state of charge is generally lowest in the early morning and battery useful life tends to be reduced by spending time at low state of charge, so by orienting landscape solar panel module 720 relatively steeply tilted toward the east, solar energy can be used to re-charge the battery earlier in the morning. In addition, orienting portrait solar panel module 710 to be relatively flat tilted towards the west can increase power production during a time of day (e.g., mid-afternoon) when power consumption by cooling equipment (e.g., in residences, in offices, in factories, etc.) tends to be relatively high, thus reducing reliance on battery discharge. The asymmetry can be achieved by having the east-facing panels mounted in a landscape orientation while the west-facing panels are mounted in a portrait orientation. When the portrait solar panel module 710 and the landscape solar panel module 720 are set up in a “tent” or inverted-V arrangement (e.g., as shown in FIG. 9A), with the solar panel modules joined to form a 90-degree angle therebetween, the portrait solar panel module 710 can be at a 33-degree angle with respect to the plane of the surface and the landscape solar panel module 720 can be at a 56-degree angle with respect to the plane of the surface. This accomplishes an asymmetric solar “tent” (or inverted-V mounting arrangement) in the absence of additional mounting elements (e.g., coupler(s)) because the frames of the solar panel modules are configured to hold each other in place. In some embodiments (e.g., embodiments that have a predefined angle other than 90 degrees), however, a coupler (e.g., coupler 530 of FIG. 5) can be used.

FIG. 8 depicts a plan view of a portrait-landscape solar tent 800, according to an embodiment. Portrait-landscape solar tent 800 includes portrait solar panel modules 810 (e.g., structurally and/or functionally similar to portrait solar panel module 710 of FIG. 7) and landscape solar panel modules 820 (e.g., structurally and/or functionally similar to landscape solar panel module 720 of FIG. 7). Portrait solar panel modules 810 include five solar panel modules, and landscape solar panel modules 820 include three solar panel modules different from the five solar panel modules of portrait solar panel modules 810. Each solar panel module from portrait solar panel modules 810 is oriented in a portrait orientation with respect to an apex of the portrait-landscape solar tent 800, and each solar panel module from landscape solar panel modules 820 is oriented in a landscape orientation with respect to the apex of the landscape-landscape solar tent 700. Each solar panel module from portrait solar panel modules 810 and each solar panel module from landscape solar panel modules 820 has substantially the same size (e.g., dimensions of length and width) and substantially the same shape (e.g., a rectangle) as the remaining solar panel modules. A set of elongated sidewalls of portrait solar panel modules 810 can be coupled together, for example via adhesives, laminates, and/or fasteners, to form a first row that abuts an apex of portrait-landscape solar tent 800. A set of shorter sidewalls of landscape solar panel modules 820 can be coupled together to form a second row that abuts the apex of portrait-landscape solar tent 800. A set of shorter sidewalls of portrait solar panel modules 810 can be affixed to a set of elongated sidewalls of landscape solar panel modules 820 to form an array that includes the first row and the second row, the first row being on one side of the apex and the second row being on an opposite side of the apex.

In FIG. 8, the plan view and the tilted configuration of the solar panel modules causes landscape solar panel modules 820 to appear narrower than portrait solar panel modules 810, and portrait solar panel modules 810 to appear shorter than landscape solar panel modules 820. In the example of FIG. 8, the cumulative length of the three landscape-oriented solar panel modules appears less than the cumulative width of the five portrait-oriented solar panel modules. The portions along the perimeter of portrait-landscape solar tent 800 are “free” portions in the sense that such portions are not connected to any other solar panel module. The tilt angles of the asymmetric portrait-landscape configuration can be altered or modified. For example, in some embodiments, landscape solar panel modules can be a type different from a type of portrait solar panel modules and can have different dimensions. For example, if landscape solar panel modules are a smaller type of solar panel module, then the portrait solar panel modules can be tilted at a smaller angle relative to the horizontal than is shown, for example, in FIG. 9A, and the landscape solar panel modules can be tilted at a larger angle relative to the horizontal than is shown in, for example, FIG. 9B. Stated similarly, in some embodiments, at least one solar panel module from a first row of solar panel modules of a portrait-landscape solar tent and/or at least one solar panel from a second row of solar panel modules of a portrait-landscape solar tent can have a size and/or a shape that is different from a size and/or shape of remaining solar panel modules. For example, in some embodiments, a first solar panel module from a first row of solar panel modules can be smaller than (or larger than) remaining solar panel modules from the first row of solar panel modules and/or smaller than (or larger than) remaining solar panel modules from a second row of solar panel modules.

In some implementations, portrait-landscape solar tent 800 can include one or more types of couplers such as, for example, the coupler 530 of FIG. 5, the couplers 1330 of FIG. 13, or another type of coupler(s) such as hinges disposed along a ridgeline (or apex) of portrait-landscape solar tent 800. In some implementations, portrait-landscape solar tent 800 can include one or more splay limiters such as, for example, the base-attached splay limiter 1430 of FIG. 14, the base-attached splay limiter 1530 of FIG. 15 and/or the ground-attached splay limiter 1630 of FIGS. 16A-16B.

FIG. 9A depicts a cross-sectional view of a portrait-landscape solar tent 901 with a right angle. The cross-sectional view of FIG. 9A is taken at cross-section line L7 of FIG. 8. Portrait-landscape solar tent 901 can be structurally and/or functionally similar to the portrait-landscape solar tent 800 of FIG. 8. As shown, portrait solar panel module 910 can be affixed to landscape solar panel module 920 such that a right angle exists between a plane of portrait solar panel module 910 and a plane of landscape solar panel module 920, a 33 degree angle exists between a surface that supports portrait-landscape solar tent 901 and portrait solar panel module 910, and a 56 degree angle exists between the surface that supports portrait-landscape solar tent 901 and landscape solar panel module 920. Portrait-landscape solar tent 901 does not include a coupler (e.g., coupler 530 of FIG. 5). In some embodiments (e.g., embodiments that have a predefined angle other than 90 degrees), a portrait-landscape solar tent can include a coupler (e.g., coupler 530 of FIG. 5).

FIG. 9B depicts a cross-sectional view of a portrait-landscape solar tent 902 with a 135 degree angle. The cross-sectional view of FIG. 9B is taken at cross-section line L8 of FIG. 8. Portrait-landscape solar tent 902 can be structurally and/or functionally similar to the portrait-landscape solar tent 800 of FIG. 8. As shown, portrait solar panel module 930 can be affixed to landscape solar panel module 940 such that a 135 degree angle exists between a plane of portrait solar panel module 930 and a plane of landscape solar panel module 940, an 18 degree angle exists between a surface that supports portrait-landscape solar tent 902 and portrait solar panel module 930, and a 27 degree angle exists between the surface that supports portrait-landscape solar tent 902 and landscape solar panel module 940. In some implementations, portrait-landscape solar tent 902 can include a coupler (e.g., coupler 530 of FIG. 5; not shown in FIG. 9B). As described in connection with FIG. 4, the tilt angles of the portrait-landscape solar tent 902 can be set, or selected, by positioning, for example, a metal angle (or other type of coupler) between the frame of the portrait solar panel module 930 and the landscape solar panel module 940 along the axis (or ridgeline) of portrait-landscape solar tent 902. FIG. 9B shows a configuration where the asymmetric portrait-landscape configuration has a 135-degree predefined angle (rather than 90 degrees), where the west-facing portion of the portrait-landscape solar tent 902 is tilted at 18 degrees and the east-facing portion of the portrait-landscape solar tent 902 is tilted at 27 degrees.

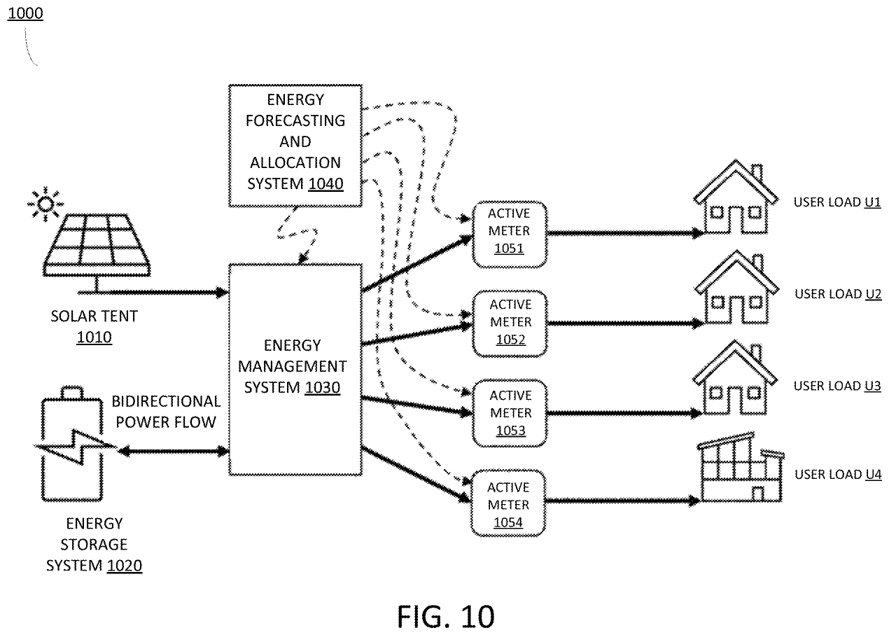

FIG. 10 is a diagram of an example microgrid system for microgrid metering and energy allocation, according to an embodiment. The example microgrid system 1000 can be compatible with one or more Firefly embodiments of the present disclosure, and is thus also referred to herein as a Firefly system. The example Firefly system 1000 includes solar tents 1010 (e.g., structurally and/or functionally similar to any of the solar tent embodiments of FIGS. 4-9B), energy storage system 1020, energy management system 1030, energy forecasting and allocation system 1040, active meter 1051, active meter 1052, active meter 1053, and active meter 1054, which can be coupled (e.g., electrically coupled, communicatively coupled, operatively coupled) together.

Energy storage system 1020 can be and/or include a battery energy storage system (BESS) including batteries, power conversion systems (e.g., rectifiers, inverters, etc.), and/or battery management systems (e.g., a processor, a memory), for the storage of energy output by solar tents 1010 and/or release of energy associated with solar tents 1010.

Energy management system 1030 can be and/or include an electric bus configured to distribute electric power based on load demand (e.g., based on user load U1, user load U2, user load U3, and/or user load U4 demand). In some implementations, energy management system 1030 can include a controller (e.g., a processor and a memory) configured to manage the distribution of electric power to the electric bus and/or from the electric bus based on load demand.

Energy forecasting and allocation system 1040 can be and/or include a compute device configured to estimate energy allowance (or demand) for user load U1, user load U2, user load U3, and/or user load U4 based on conditions of energy management system 1030 and/or based on parameters of active meter 1051, active meter 1052, active meter 1053, and/or active meter 1054 and configured to cause energy management system 1030 to distribute energy to user load U1, user load U2, user load U3, and/or user load U4 based on the estimated energy allowance(s). The compute device can include a processor and a memory that stores instructions that when executed by the processor can cause the processor to perform one or more functions described herein.

Active meter 1051 can be configured to measure power draw by user load U1. Active meter 1052 can be configured to measure power draw by user load U2. Active meter 1053 can be configured to measure power draw by user load U3. Active meter 1054 can be configured to measure power draw by user load U4. Each of user load U1, user load U2, user load U3, and user load U4 can represent different electrical loads such as, for example, appliances of a residential building, equipment of an industrial building such as a factory, compute resources of a commercial building such as an office, and/or the like. In some implementations, any of user load U1, user load U2, user load U3, and/or user load U4 can be and/or include a Common Control Service (CCS), as described below.

FIG. 10 depicts an overview of a system that can include any of the Firefly embodiments described herein. In use, the Firefly system 1000 serves several electrical loads, each marked as a “user load” and having a uniquely associated “active meter”. The active meters 1051-1054 can enable the Firefly system 1000 to control the power delivered to the user loads U1-U4, for example, to cause distribution of electric power to some user loads from user loads U1-U4 and to limit (or cause restriction of) power to one or more remaining user load(s) from user loads U1-U4. In some instances, it can be desirable to operate specified user loads during time periods when solar power production exceeds energy demand, such as Common Control Services (CCS). As used herein, the term “operate” when used with a user load refers to a nonzero power draw by the user load to support a specified function. Examples of CCS can be and/or include desalinating or purifying water, pumping ground water (e.g., for irrigation or to fill a water tower), producing ice or dry ice, producing stored heat, charging mobile batteries (phones, work vehicles) or operating micro-industries (where the economics allow operating during peak sunshine hours and not in the evenings). Firefly system 1000 can be configured to distribute power from solar tents 1010 to one or more CCS load(s) from user loads U1-U4, during operation of the one or more CCS load(s) and at a time of day that coincides with relatively greater solar power production. Through insertion of additional instances of solar tents 1010 to Firefly system 1000, Firefly system 1000 can be modularly adjusted to increase the size (i.e., the total electrical power capacity) of solar tents 1010. For example, more instances of solar tents 1010 can be deployed in Firefly system 1000 to be coupled to and to produce solar power for CCS loads, relative to the instances of solar tents 1010 that are coupled to and produce solar power for the non-CCS loads.

In some instances, Firefly system 1000 can distribute power to a user load from user loads U1-U4 according to a power demand profile other than a power demand profile that is desired by a user associated with that user load. For example, Firefly system 1000 can determine to distribute less power than is specified by the user-defined power demand profile, independent of the user-defined power demand profile. In some instances, Firefly system 1000 can control a power profile for a user load from user loads U1-U4 and can distribute power to that user load according to the system-defined power demand profile. Controlling the power demand profile for one or more user loads can have various downstream benefits.

Because the CCS loads can be under common control with the Firefly system 1000, the CCS loads can be operated to reduce the fraction of solar energy that is stored in energy storage system 1020. Reducing the amount of solar energy stored in energy storage system 1020 can reduce the average resource use, and, thus, economic cost, per unit of energy produced for all the user loads (i.e., user load U1, user load U2, user load U3, user load U4, etc.) in the Firefly system 1000 (including the CCS loads). In addition, because the size of the set of solar tents from solar tents 1010 can be larger for CCS loads relative to the size of the set of solar tents from solar tents 1010 for the non-CCS loads, more excess solar energy capacity can exist for CCS loads relative to the non-CCS loads, which reduces the likelihood that the Firefly system 1000 will fail to produce enough solar power, on a given day, to serve CCS loads or remaining user loads. Stated similarly, the service reliability to the non-CCS loads can be increased, even while using fewer resources relative to the user load(s) (and thus being able to deliver lower energy costs). FIG. 11 is a graph 1100 depicting an example power profile of a solar tent, according to an embodiment. The solar tent can be and/or include any of the embodiments described herein. In some implementations, the solar tent (e.g., solar tents 1010 of FIG. 10) can be included in a Firefly system, such as the Firefly system 1000 of FIG. 10. Graph 1100 includes a solid curve that represents the expected solar power production by the solar tent over the course of a 24-hour day, minus the power consumption by the total amount of connected non-CCS loads in the Firefly system. During the mid-part (e.g., between about hour 9 and about hour 12) of the day, the excess power produced by the solar tent can be used to charge a battery (e.g., energy storage system 1020 of FIG. 10) in the Firefly system. During the evening and through the night, the loads can be served by the battery. As depicted in graph 1100, the minimum battery state of charge occurs around hour 6, right before the excess solar power production can be used to re-charge the battery.

In some instances, for example either because of higher solar production than is typical for the day, or because of lower consumption by the non-CCS loads than is typical for the day, the excess power is expected to be higher than is typical. Graph 1100 includes a dashed line that represents the expected excess power generated by the solar tent, when excess solar power is expected to be higher than is typical (annotated as a “high surplus day”). In some such instances, the Firefly system can be configured to operate the one or more CCS loads at or with a relatively high power during the day (and, in some instances, even into the early evening), to make productive use of solar power production capacity that would otherwise be curtailed.

In some instances, for example either because of lower solar production than is typical for the day, or higher consumption by non-CCS loads than is typical for the day, the excess power is expected to be lower than is typical. Graph 1100 includes a dotted line that represents the expected excess power generated by the solar tent, when excess power is expected to be lower than is typical (annotated as a “low surplus day”). In some such instances, the Firefly system can be configured to reduce power distribution to one or more CCS loads to a relatively low power, or to reduce power distribution to a substantially zero power, to preserve the available energy and serve non-CCS loads.

Because the CCS loads absorb energy through the course of the year, the solar generating capacity of the Firefly system can be made larger than the solar generating capacity would be in the absence of CCS loads. As a result, in some instances (e.g., on days when there is a low surplus of energy available, if the CCS loads are curtailed), the total production from the larger solar capacity can be directed to serving the non-CCS loads, reducing the likelihood that insufficient solar generation to serve those loads will exist.

In some other instances (e.g., on days when there is a high surplus of energy available), the CCS loads can make productive use of the excess power, reducing the likelihood that solar generation will be curtailed. Because curtailed solar generation represents resources that are not used productively, the CCS loads reduce the risk of having non-productive resources.

Some limitations on curtailing CCS loads can exist. Consider, for example, a CCS load that is pumping water into a water tower. On any given day, if solar energy production is expected to be insufficient, the water pump can be shut off so that the solar energy can be used to power other loads and charge the BESS. Typically, excess water exists in a water tower and a community of users can draw the excess water from the water tower. If, however, a multi-day period exists when solar energy production was insufficient, failing to pump water into the tower could threaten the community's water supply. Because water access carries high priority (e.g., higher than some other consumer loads), an energy management system (e.g., energy management system 1030 of FIG. 10) of the Firefly system can be caused to allocate a sufficient (e.g., a minimum) amount of power to the water pump and to restrict power distribution to user loads with a priority lower than pumping water.

Operation of one or more CCS loads can depend on forecasts of energy production and consumer loads, for example over a multi-day look-ahead and/or no less than over the remaining time left in the current day. For example, energy forecasting and allocation system 1040 of FIG. 10 can be configured to predict forecasts associated with one or more CCS loads.

In some implementations, the CCS loads can be fully controlled by the Firefly control system. That is, the CCS loads are not merely indirectly controlled, for example by issuing a request to reduce consumption, or by using price signals in accordance with some known techniques used by larger-scale utilities. Furthermore, the CCS loads are also not controlled in a binary way, by, for example, cutting off supply (an “interruptible” load). Rather, the CCS loads can be turned up/down (i.e., receiving more power or less power, respectively) as well as on/off (i.e., receiving nonzero power or zero power, respectively), to match the total power demand of the Firefly system to the availability of energy. In some implementations, the Firefly control system can be sole source of control for the CCS loads.

Additional implementation details compatible with one or more embodiments set forth herein can be found, by way of example, in U.S. Pat. No. 12,344,147, titled “Twin-configurable architecture renewable power plant for high capacity factor servicing of controllable loads” and issued on Mar. 4, 2025, in PCT Patent Application No. PCT/US2025/020951, filed Mar. 21, 2025 and titled “Gemini Grid-Connectable Renewable Powerplant Delivering High Capacity Factor to Controllable Loads,” and in U.S. patent application Ser. No. 19/550,438, filed Jan. 15, 2026 and titled “Wind Deflector for Solar Arrays,” the entire contents of each of which are incorporated by reference herein for all purposes.

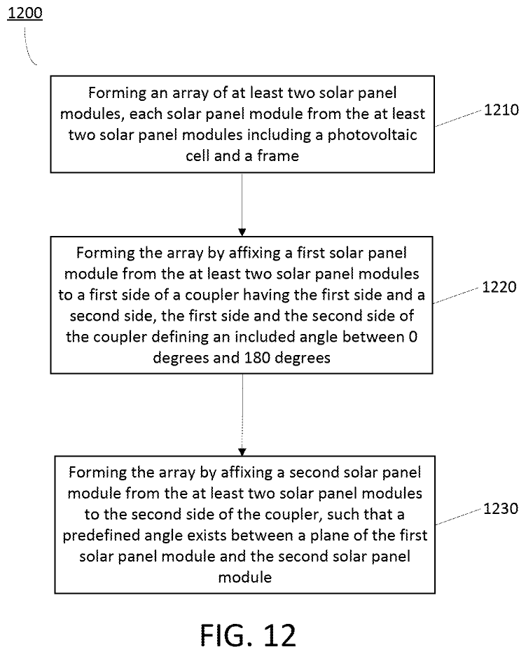

FIG. 12 is a flow diagram of a method 1200 for assembling a solar tent, according to an embodiment. Method 1200 includes, at 1210, forming an array of at least two solar panel modules, each solar panel module from the at least two solar panel modules including a photovoltaic cell and a frame. In some implementations, the array can be a landscape-landscape solar tent (e.g., the landscape-landscape solar tent of FIGS. 6A-6B). In some implementations, the array can be a portrait-landscape solar tent (e.g., the portrait-landscape solar tent(s) of FIGS. 8 and 9A-9B). At 1220, method 1200 includes forming the array by affixing a first solar panel module from the at least two solar panel modules to a first side of a coupler (e.g., coupler 530 of FIG. 5) having the first side and a second side, the first side and the second side of the coupler defining an included angle between 0 degrees and 180 degrees. Affixing can include, for example, fixedly attaching via adhesives, laminates, fasteners, epoxy, brazed joints, clamps, nuts, bolts, rivets, welds, and/or the like. At 1230, method 1200 includes forming the array by affixing a second solar panel module from the at least two solar panel modules to the second side of the coupler, such that a predefined angle exists between a plane of the first solar panel module and the second solar panel module. Affixing can include, for example, fixedly attaching via adhesives, laminates, fasteners, epoxy, brazed joints, clamps, nuts, bolts, rivets, welds, and/or the like.

FIG. 13 depicts a perspective view of an example solar tent 1300 with couplers 1330, according to an embodiment. Solar tent 1300 includes solar panel module 1310 (e.g., structurally and/or functionally similar to solar panel module 410 of FIG. 4), solar panel module 1320 (e.g., structurally and/or functionally similar to solar panel module 420 of FIG. 4), and couplers 1330. Solar panel module 1310 includes frame 1311 (e.g., structurally and/or functionally similar to frame 411 of FIG. 4). Solar panel module 1320 includes frame 1321 (e.g., structurally and/or functionally similar to frame 421 of FIG. 4). Frame 1311 of solar panel module 1310 can be mechanically coupled to frame 1321 of solar panel module 1320 by the couplers 1330.

Couplers 1330 can be configured to mechanically couple (e.g., attach, secure, etc.) solar panel module 1310 to solar panel module 1320. As shown in FIG. 13, the couplers 1330 are configured to couple portions of the sloped frame sides to each other at a fixed angle. Each of the couplers 1330 has an overall inverted-V shape that includes a triangular region and elongate side members that extend partway down the sides of solar panel module 1310 and solar panel module 1320. Alternatively, or in addition, depending on the implementation, couplers 1330 can be and/or include, for example, one or more screws, rivets, clips, adhesives, clamps, and/or the like, for example to ensure secure coupling of the couplers 1330 to the frame(s) 1311, 1321. As shown, a first coupler from couplers 1330 can be disposed on a first side of solar tent 1300 and a second coupler from couplers 1330 can be disposed on a second side of solar tent 1300 that is opposite to the first side. Each coupler from couplers 1330 can include multiple portions. For example, a first portion of the first coupler can be disposed along a sloped edge of frame 1311, with a length that is less than a length of the sloped edge of frame 1311. Similarly, a second portion of the first coupler can be disposed along a sloped edge of frame 1321, with a length that is less than a length of the sloped edge of frame 1311. In some implementations, the length of the first portion of the first coupler can be substantially the same as the length of the second portion of the first coupler. In some implementations, the length of the first portion of the first coupler can be different from the length of the second portion of the first coupler. The length of either (or both) portion(s) of the first coupler can be, for example, about an eighth of the length of the sloped edge of the respective frame, about a quarter, about a third, about half, and/or the like. A third portion of the first coupler can include a substantially triangular base disposed between the first portion of the first coupler and the second portion of the first coupler. The foregoing description also applies to the second coupler from couplers 1330 that is opposite to the first coupler. In some implementations, couplers 1330 can provide more support for maintaining the configuration of solar tent 1300 relative to another type of coupler that would join solar panel module frames along, for example, a ridgeline (or axis) of a solar tent. In some implementations, couplers 1330 can be used with other embodiments herein, for example, to provide (further) support to solar tent 500, to provide support to landscape-landscape solar tent 601, to provide support to portrait-landscape solar tent 800, etc.

In some implementations, solar tent 1300 can include one or more other types of couplers, for example, the coupler 530 of FIG. 5, or another type of coupler(s) such as hinges disposed along a ridgeline (or apex) of solar tent 1300. In some implementations, solar tent 1300 can include one or more splay limiters, for example, the base-attached splay limiter 1430 of FIG. 14, the base-attached splay limiter 1530 of FIG. 15 and/or the ground-attached splay limiter 1630 of FIGS. 16A-16B.

FIG. 14 depicts a perspective view of an example solar tent 1400 with a base-attached splay limiter, according to an embodiment. Solar tent 1400 includes solar panel module 1410 (e.g., structurally and/or functionally similar to solar panel module 410 of FIG. 4), solar panel module 1420 (e.g., structurally and/or functionally similar to solar panel module 420 of FIG. 4), and base-attached splay limiter 1430 (or simply, splay limiter 1430). Solar panel module 1410 includes frame 1411 (e.g., structurally and/or functionally similar to frame 411 of FIG. 4). Solar panel module 1420 includes frame 1421 (e.g., structurally and/or functionally similar to frame 421 of FIG. 4). Frame 1411 of solar panel module 1410 can be mechanically coupled to frame 1421 of solar panel module 1420 by splay limiter 1430.

Splay limiter 1430 can be configured to limit splaying of solar tent 1400 that could otherwise cause a ridgeline (or axis) of solar tent 1400 to collapse. Splay limiter 1430 can reduce (or eliminate) the bending moment at the apex of solar tent 1400. Splay limiter 1430 can be and/or include a cable, rope, cord, bar or any other rigid, hinged, non-rigid and/or flexible elongate member, fixedly coupled (e.g., permanently attached) or removably coupled to each of frame 1411 and frame 1421. Splay limiter 1430 can be fixedly coupled to frame 1411 and frame 1421 by, for example, making an eye (not shown) at each end of the cable (for example, by passing the cable around a thimble (not shown) and swaging it back on itself), then passing a bolt (not shown) through the thimble and either directly into frame 1411 (or frame 1421) or, alternatively, into a clamp coupled (e.g., affixed) to the frame 1411 (or frame 1421) (so as to avoid piercing frame 1411 and/or frame 1421). In some implementations, splay limiter 1430 can be installed onto solar tent 1400 in the factory rather than the field. Alternatively or in addition, in some implementations, solar tent 1400 can be or include a cable and/or rigid rod that is clipped or clamped to the solar panel modules in the field, e.g., during a time when the clamshell module cluster is deployed onto a surface. In such instances, it may be useful if the deployment team has something to support the apex of the tray while the cross-tray member is fitted.

Splay limiter 1430 includes end portion 1432 and end portion 1434. The sloped edge of frame 1411 includes corner portion 1412 and midpoint portion 1414. The sloped edge of frame 1421 includes corner portion 1422 and midpoint portion 1424. Splay limiter 1430 can be disposed at a first side of solar tent 1400 between a sloped edge of frame 1411 and a sloped edge of frame 1421. End portion 1432 of splay limiter 1430 can be mechanically coupled to midpoint portion 1414 of frame 1411. Relatedly, end portion 1434 of splay limiter 1430 can be mechanically coupled to midpoint portion 1424 of frame 1421. For example, splay limiter 1430 can be fastened to each of the solar panel modules at a location that is about half-way along its length (as shown, half-way along the sloped edge of each solar panel module). Splay limiter 1430 could be fastened to each of the solar panel modules at lower end portions of frame 1411 and/or lower end portions of frame 1421 or at any desirable point along sloped edges of frame 1411 and/or sloped edges of frame 1421. As splay limiter 1430 is moved closer to the lower end (e.g., nearer the corner portion 1412 and/or corner portion 1422) of each solar panel module, it increases the likelihood that splay limiter 1430 will interfere with the ground on, for example, an uneven surface; and as it is moved closer to the apex line (e.g., away from corner portion 1412 and/or corner portion 1422) between the solar panel modules, it increases both the tension load on splay limiter 1430 (countered by greater strength of the splay limiter) and both the tension load and bending moment on the attachment point on each solar panel module (countered by greater material strength for the solar module frame). An attachment point near the mid-point (e.g., midpoint portion 1414 and/or midpoint portion 1424) of the solar module frame (e.g., defined by frame 1411 and frame 1421) is therefore likely to be desirable in many cases.

Although obscured by the perspective view of FIG. 14, a second instance of splay limiter 1430 can be disposed at a second side of solar tent 1400 that is opposite to the first side of solar tent 1400, for example, between an opposite sloped edge of frame 1411 and an opposite sloped edge of frame 1421.

In some implementations, solar tent 1400 can include one or more couplers, for example, the coupler 530 of FIG. 5, the couplers 1330 of FIG. 13, or another type of coupler(s) such as hinges disposed along a ridgeline (or apex) of solar tent 1400. In some implementations, solar tent 1400 can include one or more other types of splay limiters, for example, the base-attached splay limiter 1530 of FIG. 15 and/or the ground-attached splay limiter 1630 of FIGS. 16A-16B.

FIG. 15 depicts a perspective view of an example solar tent 1500 with another type of base-attached splay limiter, according to another embodiment. Solar tent 1500 includes solar panel module 1510 (e.g., structurally and/or functionally similar to solar panel module 410 of FIG. 4), solar panel module 1520 (e.g., structurally and/or functionally similar to solar panel module 420 of FIG. 4), and base-attached splay limiter 1530 (or simply, splay limiter 1530). Solar panel module 1510 includes frame 1511 (e.g., structurally and/or functionally similar to frame 411 of FIG. 4). Solar panel module 1520 includes frame 1521 (e.g., structurally and/or functionally similar to frame 421 of FIG. 4). Frame 1511 of solar panel module 1510 can be mechanically coupled to frame 1521 of solar panel module 1520 by splay limiter 1530.

Splay limiter 1530 can be disposed at a first side of solar tent 1500 between a sloped edge of frame 1511 and a sloped edge of frame 1521. The sloped edge of frame 1511 includes corner portion 1512 and midpoint portion 1514. The sloped edge of frame 1521 includes corner portion 1522 and midpoint portion 1524. End portion 1532 of splay limiter 1530 can be mechanically coupled to midpoint portion 1514 of frame 1511. Relatedly, end portion 1534 of splay limiter 1530 can be mechanically coupled to midpoint portion 1524 of frame 1521. For example, splay limiter 1530 can be fastened to each of the solar panel modules at half-way along its length (as shown, half-way along the sloped edge of each solar panel module). Similarly to the splay limiter 1430 of FIG. 14, splay limiter 1530 could be fastened to each of the solar panel modules at lower end portions of frame 1511 (e.g., nearer corner portion 1512) and/or lower end portions of frame 1521 (e.g., nearer corner portion 1522) or at any reasonable point along sloped edges of frame 1511 and/or sloped edges of frame 1521.

Although obscured by the perspective view of FIG. 15, a second instance of splay limiter 1530 can be disposed at a second side of solar tent 1500 that is opposite to the first side of solar tent 1500, for example, between an opposite sloped edge of frame 1511 and an opposite sloped edge of frame 1521.

Splay limiter 1530 can be configured to limit splaying of solar tent 1500 that could otherwise cause a ridgeline (or axis) of solar tent 1500 to collapse. Splay limiter 1530 can reduce (or eliminate) the bending moment at the apex of solar tent 1500. Splay limiter 1530 can be and/or include a hinged rod having hinges 1536 that is fixedly coupled (e.g., permanently attached) to each of a sloped edge of frame 1511 and a sloped edge of frame 1521. Splay limiter 1530 can be fixedly coupled to each of the sloped edge of frame 1511 and the sloped edge of frame 1521 via, for example, a first hinge from hinges 1536 at end portion 1532, a second hinge from hinges 1536 at end portion 1534, and a third hinge from hinges 1536 at a midpoint portion of splay limiter 1530. In FIG. 15, splay limiter 1530 is in an expanded/deployed configuration, and the two halves of the hinged rod of splay limiter 1530 are substantially aligned along a straight-line axis such that substantially no angle is formed between the two halves of base-attached splay limiter 1530. In some implementations, the solar tent 1500 is configured to collapse into a “closed” configuration (e.g., for transport) by folding the solar tent 1500 in a downward direction, such that the solar panel modules 1510 and 1520 face outward/are exposed. In other implementations, the solar tent 1500 is configured to collapse into a “closed” configuration (e.g., for transport) by folding the solar tent 1500 in an upward direction, such that the solar panel modules 1510 and 1520 face inward/are protected. In such implementations, for example, splay limiter 1530 can be detachable from frame 1511 at end portion 1532 and/or detachable from frame 1521 at end portion 1534.

In some implementations, solar tent 1500 can include one or more couplers such as, for example, the coupler 530 of FIG. 5, the couplers 1330 of FIG. 13, or another type of coupler(s) such as hinges disposed along a ridgeline (or apex) of solar tent 1500. In some implementations, solar tent 1500 can include one or more other types of splay limiters such as, for example, the base-attached splay limiter 1430 of FIG. 14 and/or the ground-attached splay limiter 1630 of FIGS. 16A-16B.

FIG. 16A depicts a perspective view of an example solar tent 1600 with ground-attached splay limiters, according to an embodiment. Solar tent 1600 includes solar panel module 1610 (e.g., structurally and/or functionally similar to solar panel module 410 of FIG. 4), solar panel module 1620 (e.g., structurally and/or functionally similar to solar panel module 420 of FIG. 4), and ground-attached splay limiters 1630 (or simply, splay limiters 1630). Solar panel module 1610 includes frame 1611 (e.g., structurally and/or functionally similar to frame 411 of FIG. 4). Frame 1611 includes corner portion 1612 and corner portion 1614. Solar panel module 1620 includes frame 1621 (e.g., structurally and/or functionally similar to frame 421 of FIG. 4). Frame 1621 includes corner portion 1622 and corner portion 1624. As shown, each of the four ground-attached splay limiters 1630 can be disposed with a different corner portion from corner portion 1612, corner portion 1614, corner portion 1622, and corner portion 1624.

Ground-attached splay limiters 1630 can be configured to limit splaying of solar tent 1600 that could otherwise cause a ridgeline (or axis) of solar tent 1600 to collapse. Splay limiter 1630 can reduce (or eliminate) the bending moment at the apex of solar tent 1600. Each of the ground-attached splay limiters 1630 includes a ground-anchored foot 1632 and a retaining clamp 1634. As shown, for example, ground-anchored foot 1632 of the front-right ground-attached splay limiter can be disposed between corner portion 1622 and a surface that supports solar tent 1600. Retaining clamp 1634 can mechanically couple ground-anchored foot 1632 to corner portion 1622 of frame 1621.

In some implementations, solar tent 1600 can include one or more couplers such as, for example, the coupler 530 of FIG. 5, the couplers 1330 of FIG. 13, or another type of coupler(s) such as hinges disposed along a ridgeline (or apex) of solar tent 1500. In some implementations, solar tent 1600 can include one or more other types of splay limiters such as, for example, the base-attached splay limiter 1430 of FIG. 14 and/or the base-attached splay limiter 1530 of FIG. 15.

FIG. 16B depicts the ground-attached splay limiter of FIG. 16A, according to an embodiment. As shown in FIG. 16B, a retaining bolt 1636 can fixedly couple ground-anchored foot 1632 to retaining clamp 1634. In some embodiments, a type of coupler other than or in addition to retaining bolt 1636 can fixedly couple a ground-anchored foot to a retaining clamp to form a ground-attached splay limiter. Ground-anchored foot 1632 can have a sidewall portion configured to contact a sidewall of a frame (e.g., frame 1621 of FIG. 16A, etc.) and ground anchor 1633 configured to fix the ground-anchored foot 1632 in place relative to ground. Accordingly, ground-anchored foot 1632 can reduce (or prevent) splaying of the frame. Retaining clamp 1634 can have a sloped portion configured to clamp to a sloped edge of a frame (e.g., frame 1621 of FIG. 16A, etc.). Accordingly, retaining clamp 1634 can be a support that rigidly couples the ground-anchored foot 1632 to a frame (e.g., frame 1621 of FIG. 16A, etc.).

A ground-attached splay limiter can be installed in various ways. With reference to ground-attached splay limiter 1630, for example, ground-anchored foot 1632 can be anchored to the ground, a frame can then be mounted onto the ground-anchored foot 1632, and finally the retaining clamp 1634 can be fixedly coupled to ground-anchored foot 1632 to rigidly couple the frame to the ground-anchored foot 1632. In some embodiments, a ground-attached splay limiter can include a retaining clamp with a foot portion that, rather than facing and being disposed under a frame, faces away from a frame to be capable of being anchored to the ground without affixing the retaining clamp to a separate foot in the field. For example, such a retaining clamp can be clamped to a frame prior to a deployment phase (e.g., during a manufacturing phase), and, during a deployment phase, can be anchored to the ground without a coupling between that retaining clamp and a separate foot during the deployment phase.

In some embodiments, an apparatus includes an array of at least two solar panel modules. Each solar panel module from the at least two solar panel modules includes a photovoltaic cell and a frame from a plurality of frames. Each frame from the plurality of frames includes a first sidewall, a second sidewall opposite the first sidewall, and a third sidewall disposed between, in contact with, and substantially orthogonal to each of the first sidewall and the second sidewall. A first solar panel module from the at least two solar panel modules is fixedly attached to a second solar panel module from the at least two solar panel modules so that the third sidewall of the frame of the first solar panel module abuts at least a portion of the frame (e.g., the first sidewall, the second sidewall, or the third sidewall) of the second solar panel module such that a plane of the first solar panel module is substantially orthogonal to a plane of the second solar panel module.

In some such implementations, the first solar panel module is fixedly attached to the second solar panel module via an adhesive extending along at least a quarter of a length of the third sidewall of the frame of the first solar panel module.

In some such implementations, the first solar panel module is fixedly attached to the second solar panel module only via an adhesive.

In some such implementations, for each frame from the plurality of frames, the third sidewall is longer than the first sidewall and is longer than the second sidewall.

In some such implementations, each frame from the plurality of frames includes aluminum.

In some such implementations, the first solar panel module is fixedly attached to the second solar panel module via at least one of a clamp, a nut, a bolt, a rivet, or a weld.

In some such implementations, the third sidewall has a square U-shaped cross-section, a first arm of the square U-shaped cross section having a first length, and a second arm of the square U-shaped cross section having a second length different from the first length.

In some such implementations, each frame from the plurality of frames includes aluminum, and the first solar panel module is fixedly attached to the second solar panel module via at least one of epoxy or a brazed joint.

In some embodiments, an apparatus comprises: an array of at least two solar panel modules, each solar panel module from the at least two solar panel modules including a photovoltaic cell and a frame from a plurality of frames; and a coupler having at least a first side and a second side that define an included angle between 0 degrees and 180 degrees, a first solar panel module from the at least two solar panel modules affixed to the first side of the coupler and a second solar panel module from the at least two solar panel modules affixed to the second side of the coupler, such that a predefined angle exists between a plane of the first solar panel module and a plane of the second solar panel module.

In some such implementations, the first solar panel module is fixedly attached to the second solar panel module via an adhesive extending along at least a quarter of a length of the third sidewall of the frame of the first solar panel module.

In some such implementations, the first solar panel module is fixedly attached to the second solar panel module only via an adhesive.

In some such implementations, for each frame from the plurality of frames, the third sidewall is longer than the first sidewall and is longer than the second sidewall.

In some such implementations, each frame from the plurality of frames includes aluminum.

In some such implementations, the first solar panel module is fixedly attached to the second solar panel module via at least one of a clamp, a nut, a bolt, a rivet, or a weld.

In some such implementations, the third sidewall has a square E-shaped cross-section.

In some such implementations, each frame from the plurality of frames includes aluminum, and the first solar panel module is fixedly attached to the second solar panel module via at least one of epoxy or a brazed joint.

In some embodiments, an apparatus comprises: an array of at least two solar panel modules, each solar panel module from the at least two solar panel modules including a photovoltaic cell and a frame from a plurality of frames; and a coupler having at least a first side and a second side that define an included angle between 0 degrees and 180 degrees, a first solar panel module from the at least two solar panel modules affixed to the first side of the coupler and a second solar panel module from the at least two solar panel modules affixed to the second side of the coupler, such that a predefined angle exists between a plane of the first solar panel module and a plane of the second solar panel module.

In some such implementations, each frame from the plurality of frames includes a first sidewall, a second sidewall opposite the first sidewall, and a third sidewall extending between and substantially orthogonal to each of the first sidewall and the second sidewall, the first solar panel module affixed to the first side of the coupler via the third sidewall of the first solar panel module, and the second solar panel module affixed to the second side of the coupler via the third sidewall of the second solar panel module.

In some such implementations, the predefined angle is between about 135 degrees and about 160 degrees.

In some such implementations, the predefined angle is one of: about 135 degrees, about 140 degrees, about 145 degrees, about 150 degrees, or about 160 degrees.

In some such implementations, each frame from the plurality of frames includes a first sidewall, a second sidewall opposite the first sidewall, and a third sidewall extending between and substantially orthogonal to each of the first sidewall and the second sidewall, the first solar panel module affixed to the first side of the coupler via the third sidewall of the first solar panel module, and the second solar panel module affixed to the second side of the coupler via a portion of, and less than an entirety of, the third sidewall of the second solar panel module.

In some such implementations, the predefined angle is one of: about 135 degrees, about 140 degrees, about 145 degrees, about 150 degrees, or about 160 degrees.

In some such implementations, an included angle between the first side of the coupler and the second side of the coupler is one of: about 20 degrees, about 30 degrees, about 35 degrees, about 40 degrees, about 45 degrees, about 50 degrees, about 55 degrees, about 60 degrees, or about 70 degrees.

In some such implementations, the coupler includes extruded metal.

In some such implementations, each of the first solar panel module and the second solar panel module has a primary face and a secondary face, the primary face larger than the secondary face, the coupler has a triangular cross-section, and a vertex of the triangular cross-section of the coupler contacts the secondary face of the first solar panel module and contacts the secondary face of the second solar panel module.

In some such implementations, each of the first solar panel module and the second solar panel module has a primary face and a secondary face, the primary face larger than and substantially orthogonal to the secondary face, the coupler has a triangular cross-section, a vertex of the triangular cross-section of the coupler contacts the primary face of the first solar panel module, and the vertex of the triangular cross-section of the coupler contacts the secondary face of the second solar panel module.

In some such implementations, each frame from the plurality of frames includes aluminum, and the coupler includes at least one of epoxy or a brazed joint.

In some such implementations, the first solar panel module is attached to the second solar panel module via at least one of a clamp, a nut, a bolt, a rivet, or a weld.

In some embodiments, a method of assembling a solar panel assembly comprises: forming an array of at least two solar panel modules, each solar panel module from the at least two solar panel modules including a photovoltaic cell and a frame, by: affixing a first solar panel module from the at least two solar panel modules to a first side of a coupler having the first side and a second side, the first side and the second side of the coupler defining an included angle between 0 degrees and 180 degrees, and affixing a second solar panel module from the at least two solar panel modules to the second side of the coupler, such that a predefined angle exists between a plane of the first solar panel module and the second solar panel module.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “substantially” and “about” each refer to an equivalence that accounts for minor variations from an absolute value or absolute state. In some instances, minor variations can be attributable to manufacturing tolerances or expected fluctuations in component performance or state. For example, a first plane that is substantially parallel to a second plane is understood to mean that the first plane is 99.9% parallel, 99.5% parallel, or 99.2% parallel to the second plane. As another example, a first plane that is substantially orthogonal to a second plane is understood to mean that the first plane is 99.9% orthogonal, 99.5% orthogonal, or 99.2% orthogonal to the second plane As yet another example, a first angle (or other metric) that is substantially the same as a second angle (or other metric) is understood to mean that the first angle is 99.9% equivalent, 99.5% equivalent, or 99.2% equivalent to the second angle. As yet another example, a substantially 90-degree (or other valued) angle refers to a 90-degree (or other valued) angle that permits deviations by no more than a small tolerance (e.g., 0.0001 degrees, 0.001 degrees, 0.01 degrees, 0.1 degrees).

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
an array of at least two solar panel modules, each solar panel module from the at least two solar panel modules including a photovoltaic cell and a frame from a plurality of frames, each frame from the plurality of frames including a first sidewall, a second sidewall opposite the first sidewall, and a third sidewall disposed between, in contact with, and substantially orthogonal to each of the first sidewall and the second sidewall,
a first solar panel module from the at least two solar panel modules fixedly attached to a second solar panel module from the at least two solar panel modules so that the third sidewall of the frame of the first solar panel module abuts at least a portion of the frame of the second solar panel module such that a plane of the first solar panel module is substantially orthogonal to a plane of the second solar panel module.

2. The apparatus of claim 1, wherein the first solar panel module is fixedly attached to the second solar panel module via an adhesive extending along at least a quarter of a length of the third sidewall of the frame of the first solar panel module.

3. The apparatus of claim 1, wherein the first solar panel module is fixedly attached to the second solar panel module only via an adhesive.

4. The apparatus of claim 1, wherein for each frame from the plurality of frames, the third sidewall is longer than the first sidewall and is longer than the second sidewall.

5. The apparatus of claim 1, wherein each frame from the plurality of frames includes aluminum.

6. The apparatus of claim 1, wherein the first solar panel module is fixedly attached to the second solar panel module via at least one of a clamp, a nut, a bolt, a rivet, or a weld.

7. The apparatus of claim 1, wherein each frame from the plurality of frames has a square E-shaped cross-section.

8. The apparatus of claim 1, wherein each frame from the plurality of frames includes aluminum, and the first solar panel module is fixedly attached to the second solar panel module via at least one of epoxy or a brazed joint.

9. An apparatus, comprising:
an array of at least two solar panel modules, each solar panel module from the at least two solar panel modules including a photovoltaic cell and a frame from a plurality of frames; and
a coupler having at least a first side and a second side that define an included angle between 0 degrees and 180 degrees,
a first solar panel module from the at least two solar panel modules affixed to the first side of the coupler and a second solar panel module from the at least two solar panel modules affixed to the second side of the coupler, such that a predefined angle exists between a plane of the first solar panel module and a plane of the second solar panel module.

10. The apparatus of claim 9, wherein:
each frame from the plurality of frames includes a first sidewall, a second sidewall opposite the first sidewall, and a third sidewall extending between and substantially orthogonal to each of the first sidewall and the second sidewall,
the first solar panel module affixed to the first side of the coupler via the third sidewall of the first solar panel module, and
the second solar panel module affixed to the second side of the coupler via the third sidewall of the second solar panel module.

11. The apparatus of claim 10, wherein the predefined angle is between about 135 degrees and about 160 degrees.

12. The apparatus of claim 10, wherein the predefined angle is one of: about 135 degrees, about 140 degrees, about 145 degrees, about 150 degrees, or about 160 degrees.

13. The apparatus of claim 9, wherein:
each frame from the plurality of frames includes a first sidewall, a second sidewall opposite the first sidewall, and a third sidewall extending between and substantially orthogonal to each of the first sidewall and the second sidewall,
the first solar panel module affixed to the first side of the coupler via the third sidewall of the first solar panel module, and
the second solar panel module affixed to the second side of the coupler via a portion of, and less than an entirety of, the third sidewall of the second solar panel module.

14. The apparatus of claim 13, wherein the predefined angle is one of: about 135 degrees, about 140 degrees, about 145 degrees, about 150 degrees, or about 160 degrees.

15. The apparatus of claim 9, wherein an included angle between the first side of the coupler and the second side of the coupler is one of: about 20 degrees, about 30 degrees, about 35 degrees, about 40 degrees, about 45 degrees, about 50 degrees, about 55 degrees, about 60 degrees, or about 70 degrees.

16. The apparatus of claim 9, wherein the coupler includes extruded metal.

17. The apparatus of claim 9, wherein:
each of the first solar panel module and the second solar panel module has a primary face and a secondary face, the primary face larger than the secondary face,
the coupler has a triangular cross-section, and
a vertex of the triangular cross-section of the coupler contacts the secondary face of the first solar panel module and contacts the secondary face of the second solar panel module.

18. The apparatus of claim 9, wherein:
each of the first solar panel module and the second solar panel module has a primary face and a secondary face, the primary face larger than and substantially orthogonal to the secondary face,
the coupler has a triangular cross-section,
a vertex of the triangular cross-section of the coupler contacts the primary face of the first solar panel module, and
the vertex of the triangular cross-section of the coupler contacts the secondary face of the second solar panel module.

19. The apparatus of claim 9, wherein each frame from the plurality of frames includes aluminum, and the coupler includes at least one of epoxy or a brazed joint.

20. The apparatus of claim 9, wherein the first solar panel module is attached to the second solar panel module via at least one of a clamp, a nut, a bolt, a rivet, or a weld.

21. A method of assembling a solar panel assembly, the method comprising:
forming an array of at least two solar panel modules, each solar panel module from the at least two solar panel modules including a photovoltaic cell and a frame, by:
affixing a first solar panel module from the at least two solar panel modules to a first side of a coupler having the first side and a second side, the first side and the second side of the coupler defining an included angle between 0 degrees and 180 degrees, and
affixing a second solar panel module from the at least two solar panel modules to the second side of the coupler, such that a predefined angle exists between a plane of the first solar panel module and the second solar panel module.
